(19) United States
(12) Patent Application Publication
(10) Pub. No.: US 2010/0030663 A1
(43) Pub. Date: Feb. 4, 2010

(54) SYSTEM AND METHOD FOR NETWORKING SHOPS ONLINE AND OFFLINE

(75) Inventors: Louise J. Wannier, Pasadena, CA (US); James P. Lambert, Toluca Lake, CA (US); Eric Jennings, Reno, NV (US); Mercedes De Luca, Saratoga, CA (US); Louisa Anna Simpson, Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: myShape, Inc., Pasadena, CA (US)

(21) Appl. No.: 12/494,242

(22) Filed: Jun. 29, 2009

Related U.S. Application Data
(60) Provisional application No. 61/077,116, filed on Jun. 30, 2008.

(51) Int. Cl. G06Q 30/00; G06Q 10/00

(52) U.S. Cl. 705/27; 705/28

(57) ABSTRACT

A computer implemented method presents garments to a consumer using a computer by reading a garment database. The database includes garments from a plurality of retail, manufacturing, and media partners. Media and retail partners combine inventories on data servers and allow each partner to show a particular offering of garments at their website. A given partner may tailor the particular garment offering to subscribers based on a profile relating to the garment parameters contained within the database inventory. Applications within the system produce outfits composed of garment selections based on particular user profile information. Outfits selections are presented to the user through a web browser where shopping and purchasing of various garments may be conducted. The computer implemented method is facilitated through databases, database servers, application servers and networks to interrelate inventory offerings between the partners.

### CROSS-REFERENCE TO RELATED APPLICATIONS

This application claims benefit under 35 U.S.C.119(e) of U.S. Provisional Patent Application No. 61/077,116, filed Jun. 30, 2008, which is herein incorporated by reference in its entirety for all purpose.

The present disclosure may be related to the following commonly assigned applications/patents:
U.S. Pat. No. 7,398,133 entitled “Matching the Fit of Individual Garments to Individual Consumers” issued to Wannier et al. (hereinafter “Wannier I”);
U.S. patent application Ser. No. 11/697,688, filed Apr. 6, 2007, entitled “Computer System for Rule-Based Clothing Matching and Filtering Considering Fit Rules and Fashion Rules” in the name of Wannier et al. (hereinafter “Wannier II”);
U.S. Provisional Patent Application No. 61/049,431, filed May 1, 2008, entitled “System and Method for Networking Shops Online and Offline” in the name of Wannier et al. (hereinafter “Wannier III”); and

U.S. Provisional Patent Application No. 61/077,118 filed of even date herewith, entitled “System and Method for Networking Shops Online and Offline” in the name of Wannier et al. (hereinafter “Wannier IV”).

The respective disclosures of these applications/patents are incorporated herein by reference in their entirety for all purposes.

### FIELD OF THE INVENTION

The present invention relates generally to computer systems for providing consumer access to databases of clothing items and in particular to computer systems that programmatically match clothing items with individual consumers' data, possibly including searching, sorting, ranking, and filtering database items from a plurality of partners.

### BACKGROUND OF THE INVENTION

Consumers often have difficulties finding apparel that fits and flatters. III-fitting garments do not sell and are often returned when they do sell. One cause of fit problems is a lack of standards. Without standardization, the garment size for an individual often differs from one brand of apparel to another. There have been multiple attempts to establish commercial standards for sizing garments. Clothing manufacturers and retailers have repeatedly redefined the previous standards or invented their own proprietary sizing schemes. Even within a single size from a single manufacturer, there can be fit problems because of a wide variation in consumers' body shapes. The lack of sizing standards combined with unreliable labeling can cause apparel fit problems, which in turn causes a very high rate of apparel returns, lost sales, brand dissatisfaction, time wasted in fitting rooms, and intense consumer frustration.

As more consumers rely on online information about products for purchase, more merchants provide electronic access to information about goods and services over the Internet. Typically, a merchant compiles a database of products and/or services, which may include information about a product's size, color, type, description, price, etc. Consumers can view the merchant's offerings over the Internet, select items of interest, and place orders with the merchant's interface.

Online shopping is significantly restricted compared to visiting a store in person. The consumer has no direct contact with the product. Where the product has a greater personal impact, such as fit, this shortcoming has more significance. For example, in fashion shopping, ordering clothing, accessories, shoes, purses, and any products incorporating a style sense, online shopping is limited. Fashion intrinsically includes shopping and purchasing something that is new and different. In clothing shopping, without the actual garment to see and try on, there is no way to visualize how the article matches a particular fashion sense or fits.

A number of approaches have been tried to bridge the gap between online shopping for clothing, shoes, or other fashion items and having the item in hand to try on. One approach has been to custom tailor the article of clothing from the customer's measurements. Other approaches have incorporated a scanned image of the customer with a geometric model of a garment that, when combined through computer graphic techniques, provides an image of the consumer wearing the garment. A further system relates photographic color systems to a color classification scheme. Colors may be automatically grouped by a fashion type, stylist, or particular color palette. One system categorizes women into “winter, summer, fall, spring” color palettes, based on their skin, eye and/or hair colors.

An improved system and method for providing clothing choices to consumers and other individuals is needed.

### BRIEF SUMMARY OF THE INVENTION

In embodiments of computer-implemented methods for matching fit and fashion of individual garments to individual consumers according to the present invention, a server system accessible to users using client systems can match consumers with garments and provide an improved, online, clothes shopping system, where a consumer is presented with a personalized online clothing store, wherein the consumer using a consumer client system can browse a list of garments matching the consumer's dimensions, body shape, preferences and fashion needs, wherein the garments are also filtered so that those shown also match fit and fashion rules so that selected garments have a higher probability of both fitting and flattering.

Clothing choices provided can include articles of clothing such as pants, hats, jackets, skirts, blouses, shoes, etc. as well as accessories, purses, and/or other products incorporating a style sense or otherwise needing to be coordinated with clothing purchases. Thus, features relating to garments or clothing can be extended to other items that relate with clothing.

A computer implemented method may present garments to a consumer using a computer by reading a database of garments, wherein the database of garments includes parameters for at least some of the garments represented by records in the database of garments. A database of garments is established from a plurality of retailers, merchants, and manufactures. By incorporating eight or so user measurements and body shape data, available from a user supplied profile, a match assessment may be made to any of a plurality of garments and accessories available in the database. In this way, the plurality of partners may make a wide variety of clothing articles available to a large number of online users. The online shopping experience can be provided through a wide ranging collection of databases, database servers, applications, application servers, and networks.

The following detailed description together with the accompanying drawings will provide a better understanding of the nature and advantages of the present invention.

### BRIEF DESCRIPTION OF THE DRAWINGS

FIG. 1 is an illustration of a clothes shopping system, in accordance with described embodiments.

FIG. 2 is a simplified block diagram of a consumer-garment matching method, in accordance with described embodiments.

FIG. 3 is a simplified block diagram of a definition process, in accordance with described embodiments.

FIGS. 4A-D illustrate height and length measurement techniques, in accordance with described embodiments.

FIGS. 5a-b are simplified block diagrams of a categorization process, in accordance with described embodiments; FIG. 5a shows a consumer recording process and FIG. 5b shows a garment recording process.

FIG. 6 is a simplified block diagram of a match assessment process, in accordance with described embodiments.

FIGS. 7-13 are flowcharts illustrating a match assessment process for a fitted dress, in accordance with described embodiments.

FIG. 14 is an illustration of example output from a match assessment process, in accordance with described embodiments.

FIG. 15 is an illustration of a garment display interface, in accordance with described embodiments.

FIGS. 16-18 are illustrations of clothes shopping systems, in accordance with described embodiments.

FIG. 19 is a block diagram of a linked lists creation process in accordance with described embodiments.

FIG. 20 is an illustration of a clothes shopping system, in accordance with described embodiments.

FIG. 21 is a block diagram of an outfit presentation process in accordance with described embodiments.

FIGS. 22-24 are block diagrams of a body shape, consumer, and garment categorization processes, in accordance with embodiments of the invention.

FIG. 25 is an illustration of a match system, in accordance with embodiments of the invention.

FIG. 26 is an illustration of a clothes shopping system, in accordance with described embodiments.

FIG. 27 is a block diagram of a preferred fashion presentation process in accordance with described embodiments.

FIGS. 28-30 are block diagrams of a fashion product and accessory presentation and recommendation processes in accordance with described embodiments.

FIG. 31 is a block diagram of an altered garment presentation process in accordance with described embodiments.

FIG. 32 is a block diagram of a garment profiling process in accordance with described embodiments.

### DETAILED DESCRIPTION

An improved online clothes shopping system is described herein, where a consumer is presented with a personalized online store that lists clothing items for sale that are most likely to fit and flatter the consumer and match their preferences for style. The presented list of items can be generated by a computerized garment-consumer matching method that matches the fit and fashion of individual clothing items to individual consumers.

Clothing items are commonly thought to include garments (dresses, coats, pants, shirts, tops, bottoms, socks, shoes, bathing suits, capes, etc.), but might also include worn or carried items such as necklaces, watches, purses, hats, accessories, etc. In any of the following examples, sized and fitted garments are the items being shopped for, but it should be understood that unless otherwise indicated, the present invention may be used for shopping for other clothing items as well. As used herein, an outfit is a collection of two or more clothing items intended to be worn or used together.

In describing embodiments of the invention, female consumers and women's apparel will serve as examples. However, the invention is not intended to be limited to women's apparel as the invention may be used for various types of apparel including men's and children's apparel. Throughout this description the embodiments and examples shown should be considered as exemplary rather than limitations of the present invention.

In a matching process, garments and consumers are compared. For garments, the measurements, style/proportion and attributes (color, weave, fabric content, price, etc.) might be taken into account, while for the consumer, measurements, body proportion (such as shape code), and consumer fit, style, and fashion preferences (how snug/loose, color, classic/contemporary/romantic, etc.), may be considered.

Fashion rules can be defined for various garment style(s) that suit body proportions, for garments and outfits, including accessorizing. Fashion rules (programmatically defining fashion expertise) can be “overlaid” on the matches to recommend the best combinations that will fit and flatter. In this manner, a consumer is presented with a number of garments to choose from, where each is likely to be a “good choice”, while 1 garments that are less likely to fit or flatter our left out. There could be a wide variety of garments and styles, etc., but they are organized as a personal store for that consumer.

### Clothes Shopping System

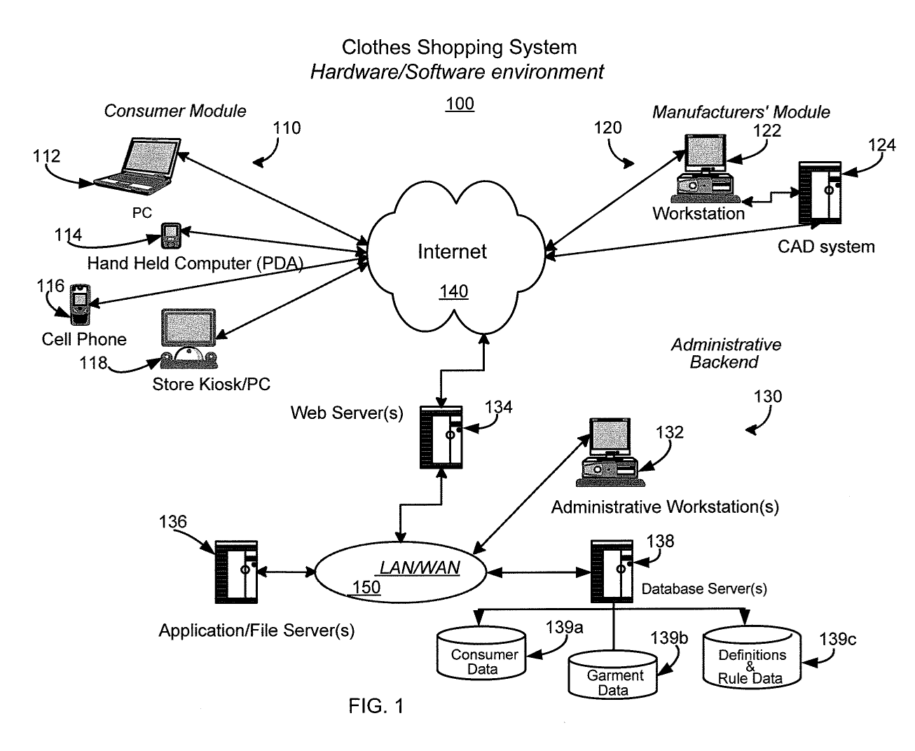

FIG. 1 is a high-level diagram depicting a clothes shopping system 100, which can be a computer implementation of a consumer-garment matching method in accordance with one embodiment of the present invention. The clothes shopping system can be a client-server system, i.e., an assemblage of hardware and software for data processing and distribution by way of networks, as those with ordinary skill in the art will appreciate. The system hardware may include, or be, a single or multiple computers, or a combination of multiple computing devices, including but not limited to: PCs, PDAs, cell phones, servers, firewalls, and routers.

As used herein, the term software involves any instructions that may be executed on a computer processor of any kind. The system software may be implemented in any computer language, and may be executed as compiled object code, assembly, or machine code, or a combination of these and others. The software may include one or more modules, files, programs, and combinations thereof. The software may be in the form of one or more applications and suites and may include low-level drivers, object code, and other lower level software.

The software may be stored on and executed from any local or remote machine-readable media, for example without limitation, magnetic media (e.g., hard disks, tape, floppy disks, card media), optical media (e.g., CD, DVD), flash memory products (e.g., memory stick, compact flash and others), Radio Frequency Identification tags (RFID), SmartCards™, and volatile and non-volatile silicon memory products (e.g., random access memory (RAM), programmable read-only memory (PROM), electronically erasable programmable read-only memory (EEPROM), and others), and also on paper (e.g., printed UPC barcodes).

Data transfer to the system and throughout its components may be achieved in a conventional fashion employing a standard suite of TCP/IP protocols, including but not limited to Hypertext Transfer Protocol (HTTP) and File Transfer Protocol (FTP). The eXtensible Markup Language (XML), an interchange format for the exchange of data across the Internet and between databases of different vendors and different operating systems, may be employed to facilitate data exchange and inter-process communication. Additional and fewer components, units, modules or other arrangement of software, hardware and data structures may be used to achieve the invention described herein. An example network is the Internet, but the invention is not so limited.

In one embodiment, a clothes shopping system 100 comprising of a consumer module 110, a manufacturer module 120, and an administrative backend 130, all networked over local and/or wide area networks (LAN/WAN) 150, and the Internet 140. The administrative backend 130 uses administrator workstations 132, web servers 134, file and application servers 136, and database servers 138 that incorporate consumer-garment matching software, the consumer and garment record databases 139a-139b, definition & rules database 139c. The manufacturer module 120 uses software/hardware that allows a manufacturer to input data into the garment records. This data may be entered via a workstation 122 or by interfacing with the manufacturer's internal systems, such as CAD systems 124. This inputted garment data is subjected to a categorization process 220. The consumer module 110 is accessed via personal computers at home, office 112, or by cellular phones 116, PDAs 114, and kiosks 118.

### The Consumer-Garment Matching Method

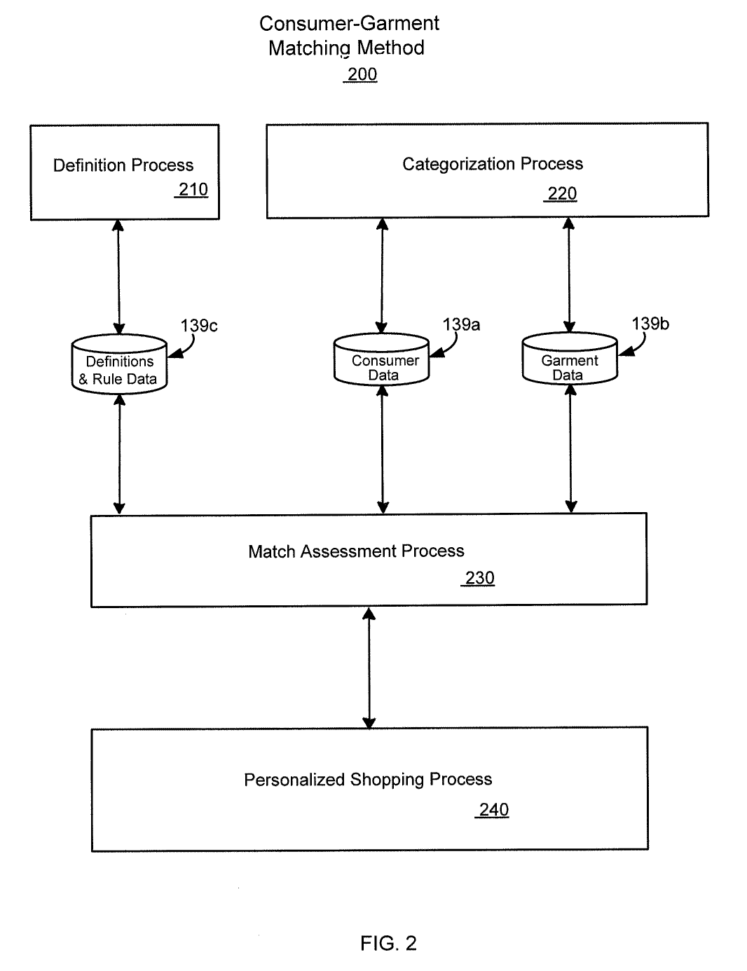

FIG. 2 is a simplified block-diagram depicting a consumer-garment matching method 200 and the data inputs, outputs and interdependence of its constituent processes: a definition process 210, a categorization process 220, a match assessment process 230, and a personalized shopping process 240, described herein.

### Definition Process

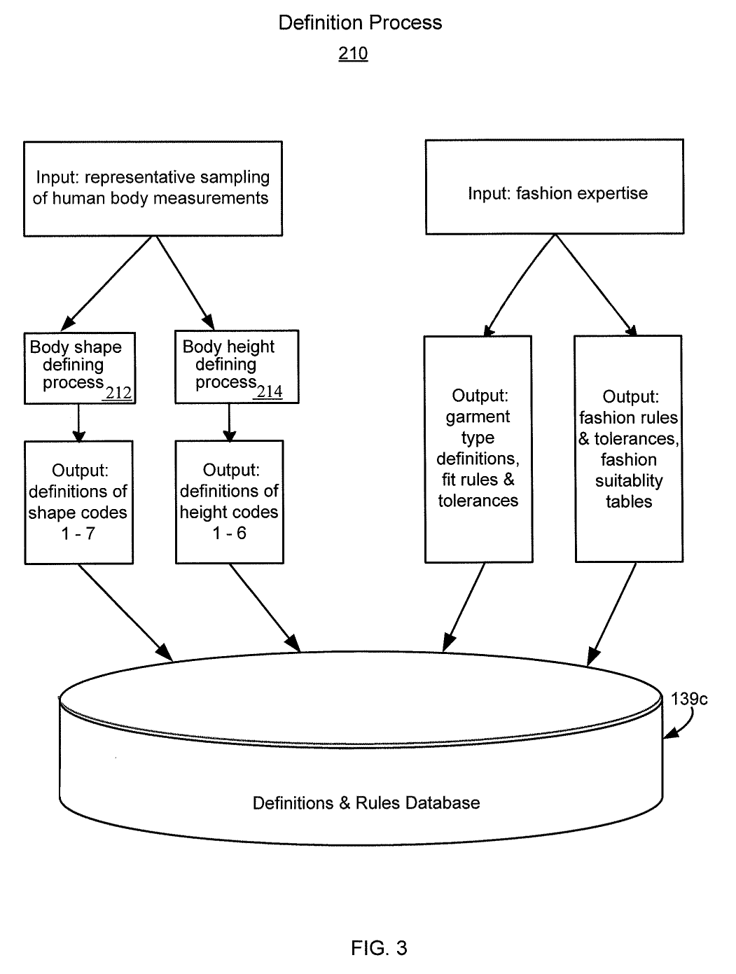

FIG. 3 depicts a definition process 210. Sets of measurements may be used by the categorization process 220 when collecting body measurement data from any individual consumer via the consumer module 110.

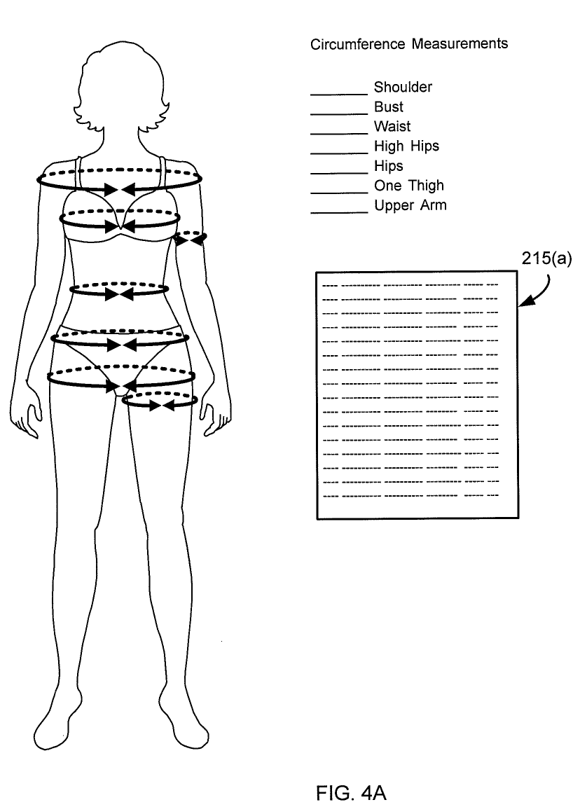

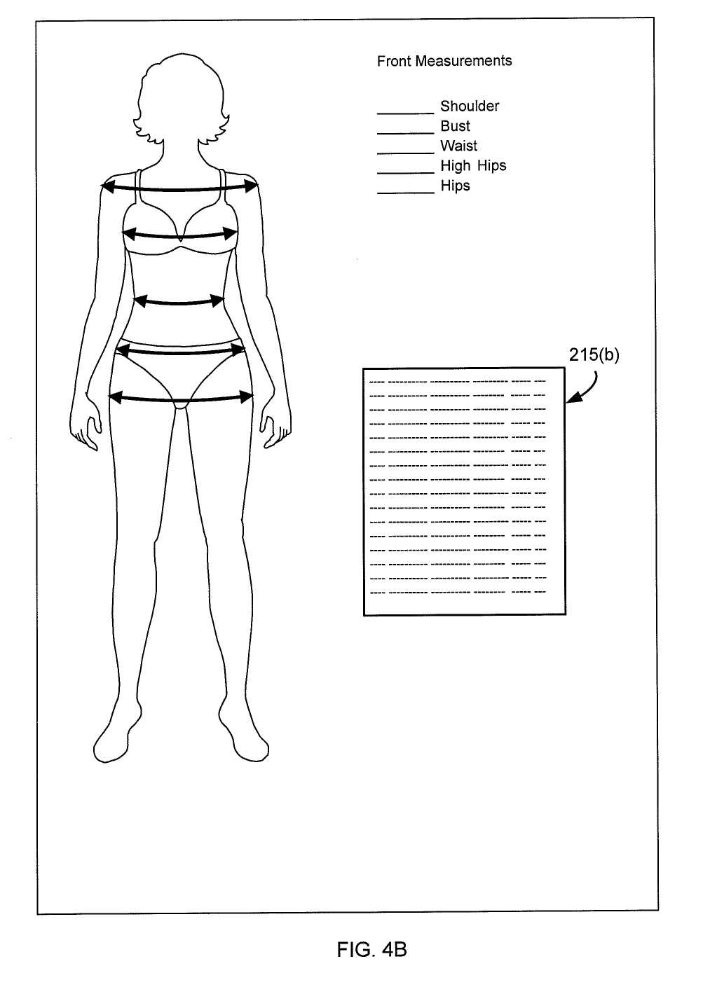

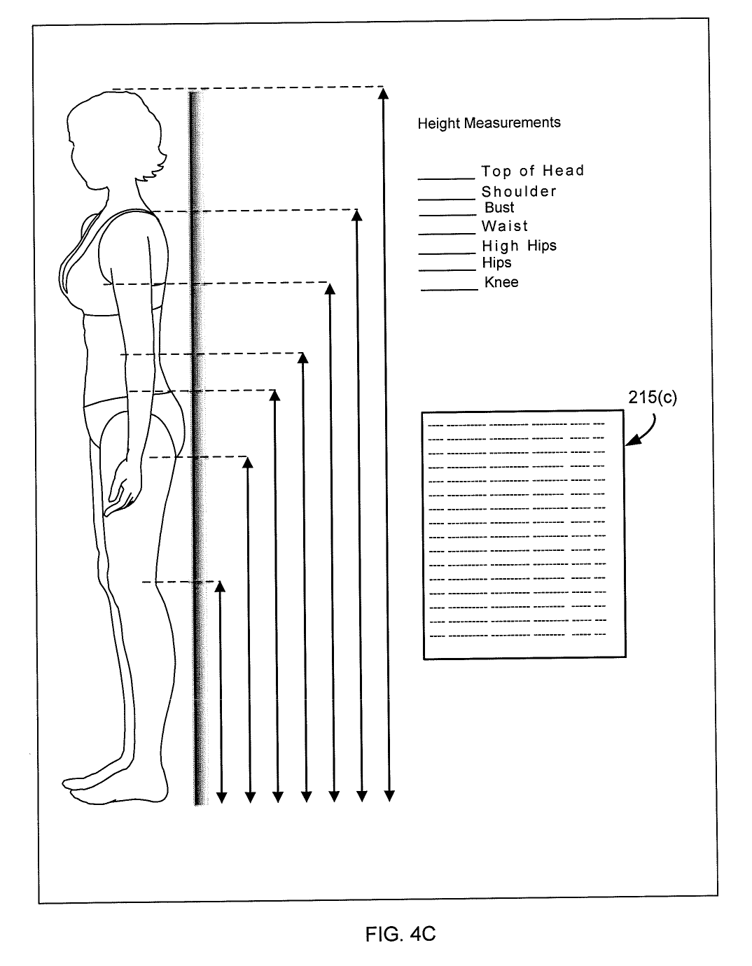

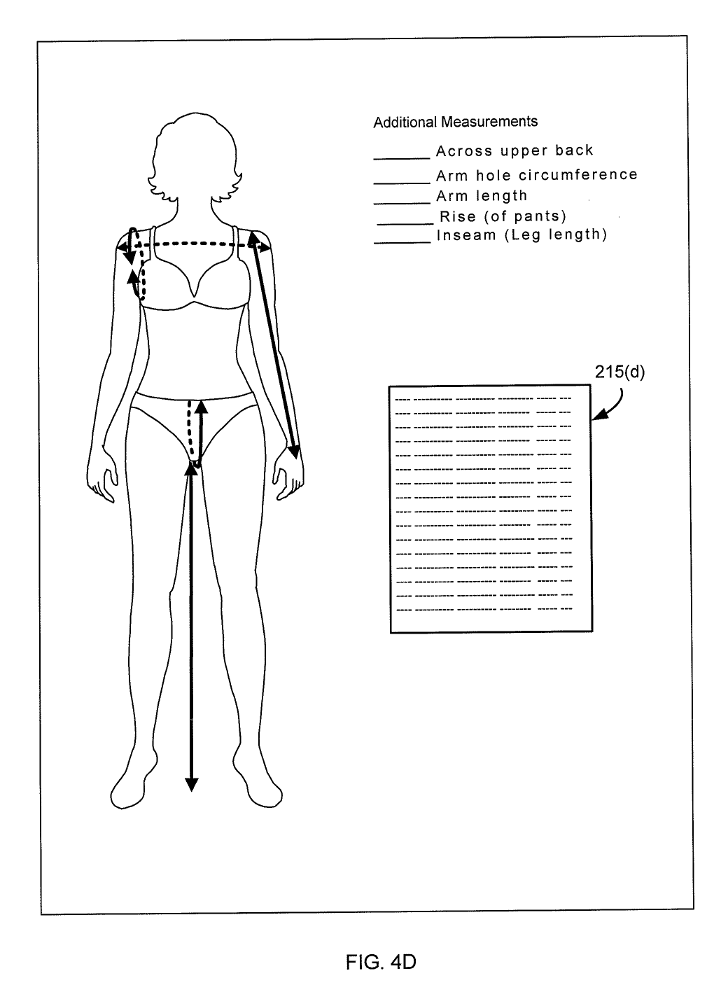

FIGS. 4A-4D depict the positions and techniques for acquiring body measurements to obtain consumer data shown in Table 1, as an example. The displays of FIGS. 4A-4D might include instructions to the reader, as instruction blocks 215(a), 215(b), 215(c) and 215(d). Examples of instruction blocks are:

215(a) in FIG. 4A:

Measure the CIRCUMFERENCE of your body at various points.
Shoulders: Measure around shoulders, just below the shoulder joint, going outside your arms at the widest point.
Bust: Measure bust at fullest point and straight across back.
Waist: Measure around torso at your waistline.
High Hips Measure over top of hip bones, 2″-4″ below waist.
Hips: Measure at the fullest part, usually 7″-9″ from waist.
One Thigh Measure at the fullest part of one thigh on one leg (your choice).
Upper Arm: Measure the circumference of the thickest part of your upper arm (that bicep muscle!).

215(b) in FIG. 4B:
Measure the FRONT OF YOU from the middle of one side to the middle of the other only. It helps if you are wearing lightweight, form fitting clothes with side seams to help locate the side of your body.
Front of Shoulders: Measure from mid point of upper arm just below the shoulder joint to the same point of the opposite side, crossing the front of your body.
Front of bust: Measure from as close to middle of one side of your body to the middle of the other crossing over the fullest part of your bust.
Front of Waist: Measure from middle of one side to the middle of the other at your waist.
Front of High Hips: Measure over top of hip bones, 2″-4″ below waist.
Front of Hips: Measure from the middle of one side to the middle of the other at the fullest part of your hips, usually 7″-9″ from waist.

215(c) in FIG. 4C:
Measure the HEIGHT of the following by taping or attaching a measuring tape to the bottom of a wall or doorway (floor—measurement zero) to measure the heights. A book, ruler or straight edge can help. This will give a vertical silhouette.
Top of head: Measure from the floor to the top of your head.
Should height: Measure from the floor to the top of your shoulder joint.
Bust height: Measure from the floor to the fullest point of your bust.
Waist Height: Measure from the floor to your waistline.
High hip height: Measure from the floor to your high hip (your hip bone, usually 2″-4″ below your waist).
Hip height: Measure from the floor to the fullest point of your hips.
Knee height: Measure from the floor to the mid-point of your knee.

215(d) in FIG. 4D:

Almost done, just a few more!
Across upper back: Measure across your upper back from end of shoulder joint to end of shoulder joint. Or, for a shortcut, use a favorite jacket, measuring from shoulder seam to shoulder seam.
Arm hole circumference: Measure top of should under arm and back around to the top of the arm.
Arm length: Measure from the middle of the shoulder joint to the wrist joint, with slightly bent elbow.
Rise (of pants): Start at middle for your waist in back, pass tape measure between your legs and up to the middle of your waist in front. Do not pull tight on this measurement, and don't make it too loose. Keep comfort in mind and make sure you are measuring your body accurately. A shortcut is to measure your favorite pair of pants.
Inseam (leg length): Measure from the crotch to the floor on the inside of your leg.
Or, for a shortcut, measure the inseam of your favorite pair of pants.

Human body shapes are defined by a body shape defining process 212. Similarly, the same sample body measurement data form the inputs of a body height defining process 214. Definitions of body shape codes and body height codes are stored in the definitions & rules database 139c as maintained by database server 138. Thus these body shape codes may then be assigned by the categorization process 220. A similar or identical set of measurements may be used by the categorization process 220 when collecting garment measurement data for any individual garment via the manufacturer module 120. A garment type definition table specifies the measurements, tolerances and order of calculation to be used by the measurement filter 232 during a match assessment 230. Garment type definitions together with their fit rules and tolerances are stored in a definitions & rules database 139c as maintained by database server 138. The Fashion rules, tolerances and fashion suitability tables are stored by the definition process 210 in a definitions & rules database 139c as maintained by database server 138.

### Categorization Process

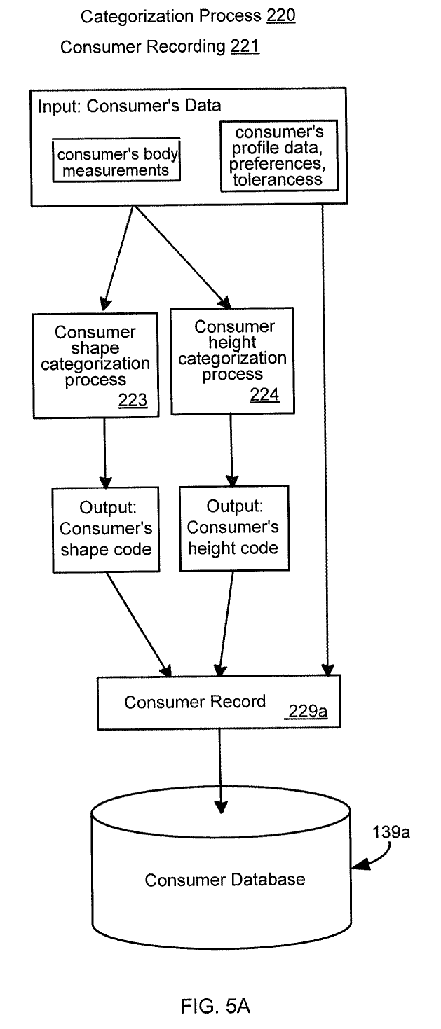

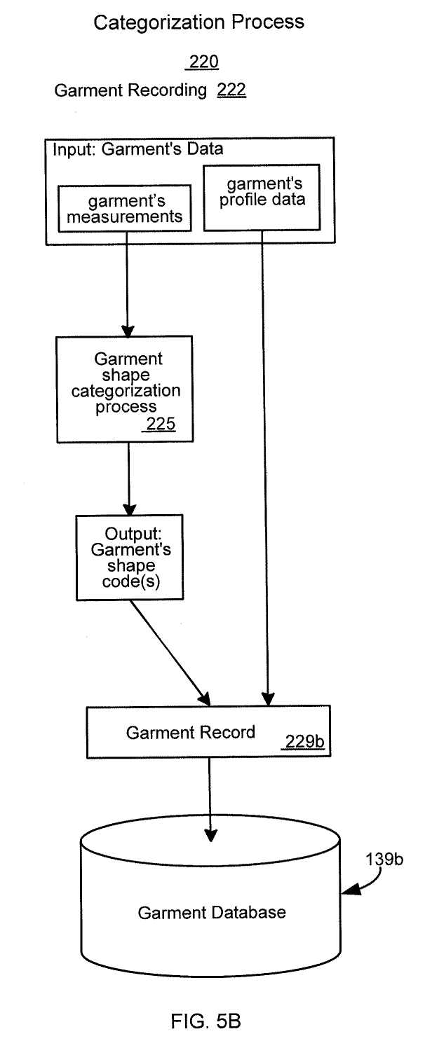

As embodied herein and depicted in FIGS. 5a-5b, a categorization process 220 has two sub-processes: consumer recording 221 (FIG. 5a) and garment recording 222 (FIG. 5b).A consumer record 229a is data describing an individual consumer. A garment record 229b is data describing an individual garment, including its measurements and profile, e.g., its color, fabric, tolerances, etc. Garments may be sewn clothing items such as dresses, coats, pants, shirts, tops, bottoms, socks, shoes, bathing suits, capes, etc., but also include worn or carried items such as necklaces, watches, purses, hats, accessories, etc. The categorization process treats either a clothing item or a fashion accessory as a garment having a garment record 229b that may include measurement and/or profile data as taught in Wannier I, Table 3 Garment Measurements and Table 4 Garment Profile Data. An example of an accessory's garment profile data are shown below in Part 4 Handbag of Table 1—Outfit Template. The consumer records 229a are stored by the categorization process 220 in a consumer database 139a, while garment records 229b are stored in a garment database 139b. In addition to the thirty-two data points given as an example consumer profile in Wannier I, Table 2, any number of different or additional data points may describe the consumer, including but not limited to hair color, face shape and other body, style or preference details. The consumer and garment databases are maintained by database server 138.

### Consumer Recording

An individual consumer's body measurements, such as those depicted in FIGS. 4A-4D, are input into a consumer shape categorization process 223. The resulting shape code is assigned to the consumer and stored in her record 229a. A consumer height categorization process 224 calculates a consumer's height code. The height categorization process is used to assign a height code to a consumer. The assigned height code can be stored in the consumer's record 229a.

### Garment Recording

The manufacturer module 120, described herein, supplies the garment measurements and profile data that form the inputs of the garment recording process 222. Referring again to FIGS. 5a-5b, a garment's measurements are inputs to a garment shape categorization process 225. The resulting shape codes are assigned to the garment and stored in its garment record 229b. The consumer records 229a can be stored in a consumer database 139a, while garment records 229b can be stored in a garment database 139b. The consumer and garment databases can be maintained by database server 138.

### Match Assessment Process

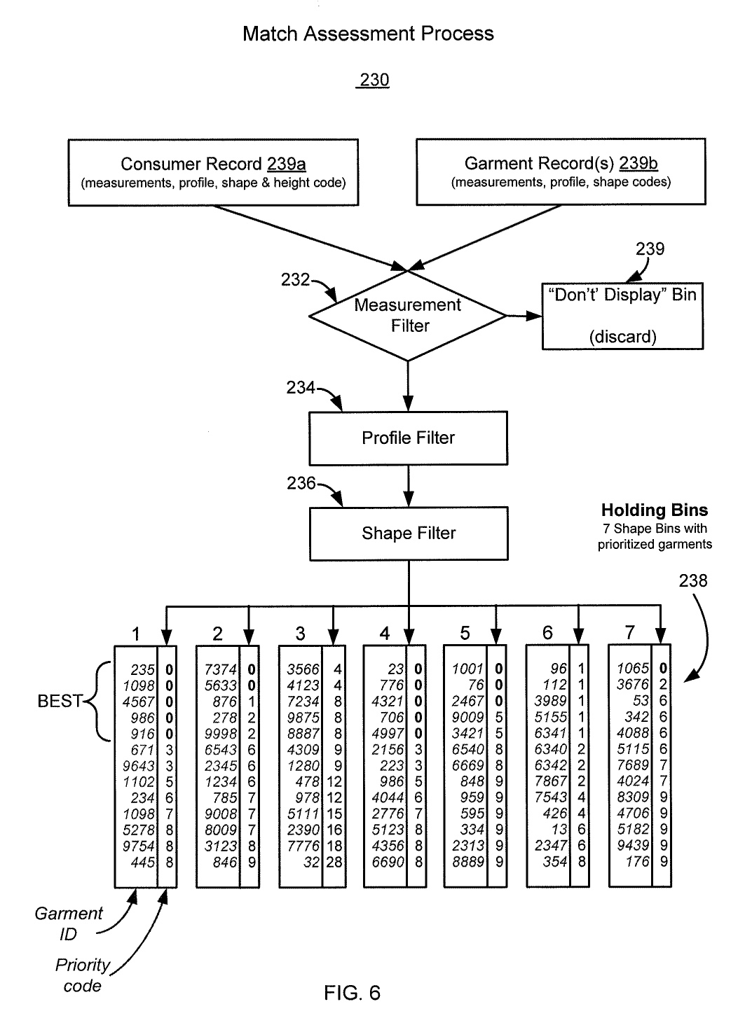

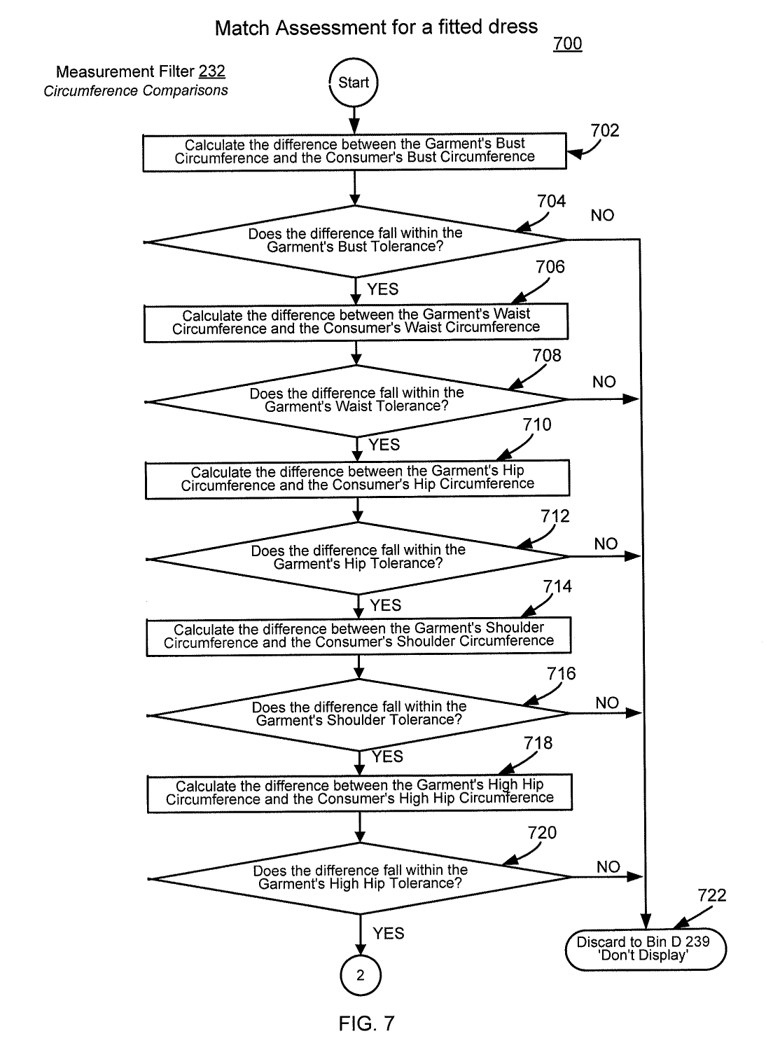

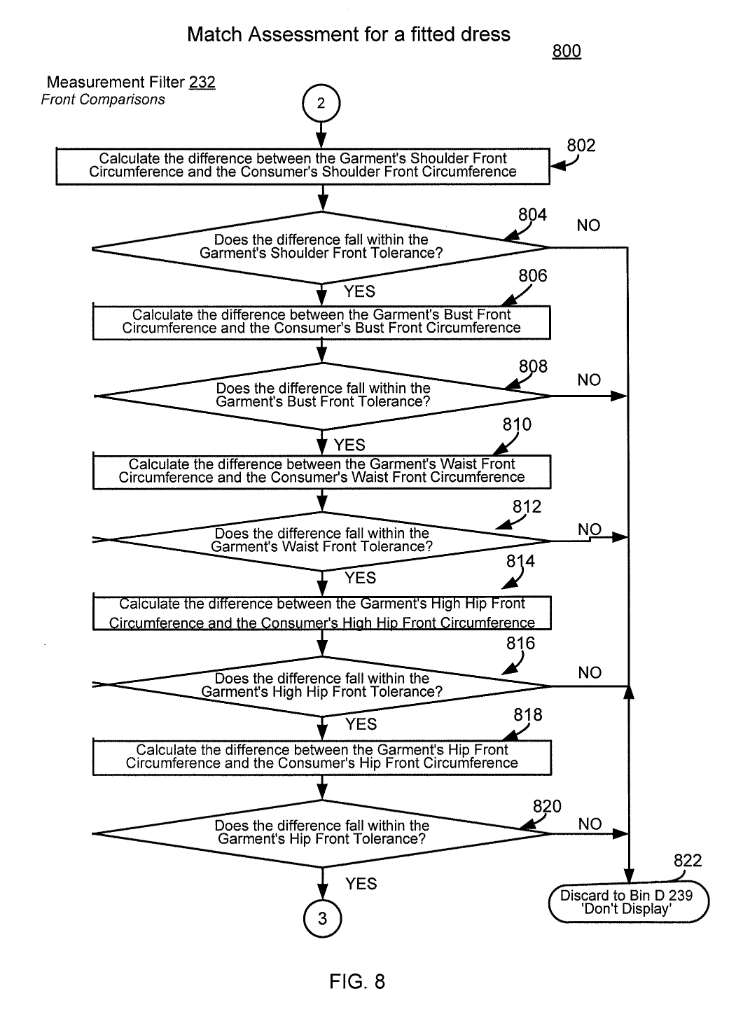

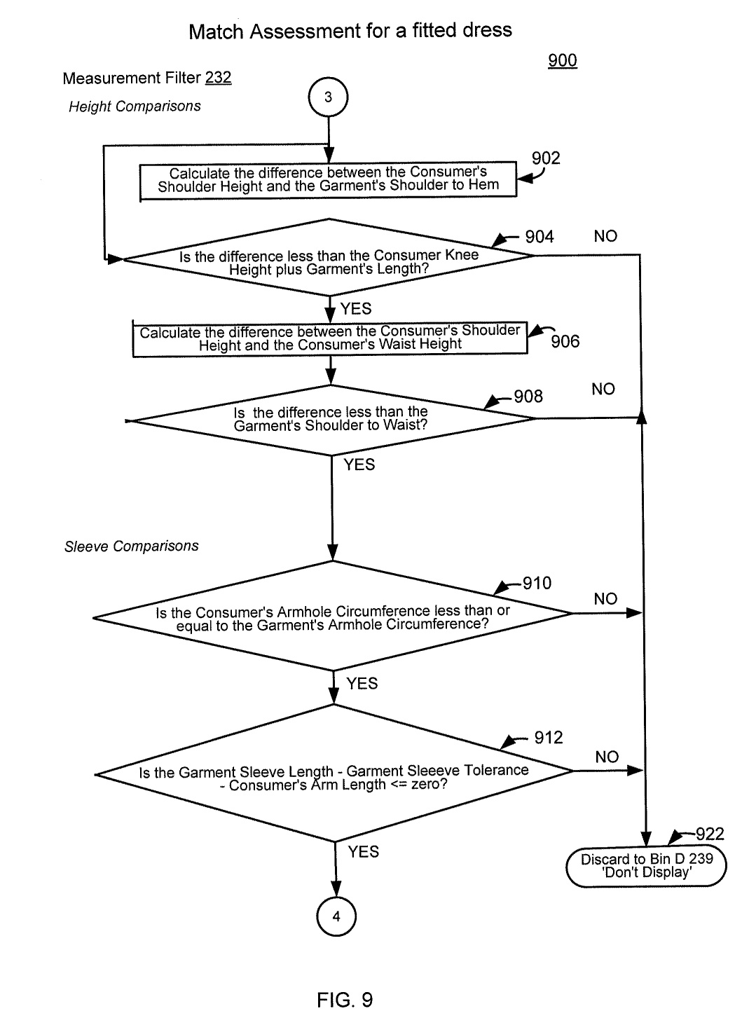

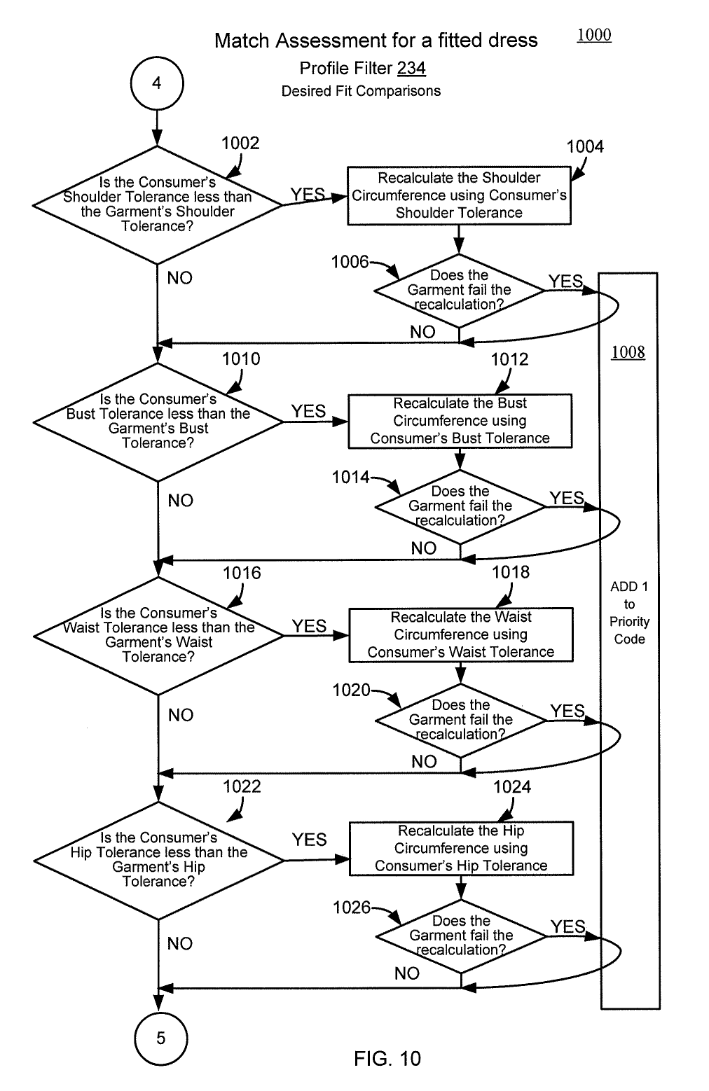

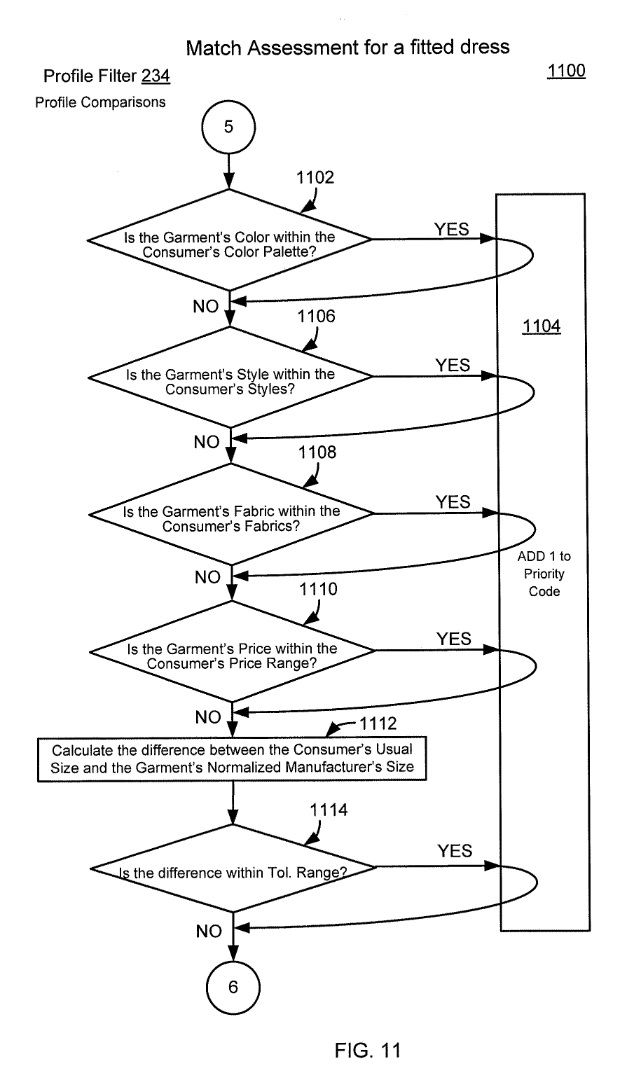

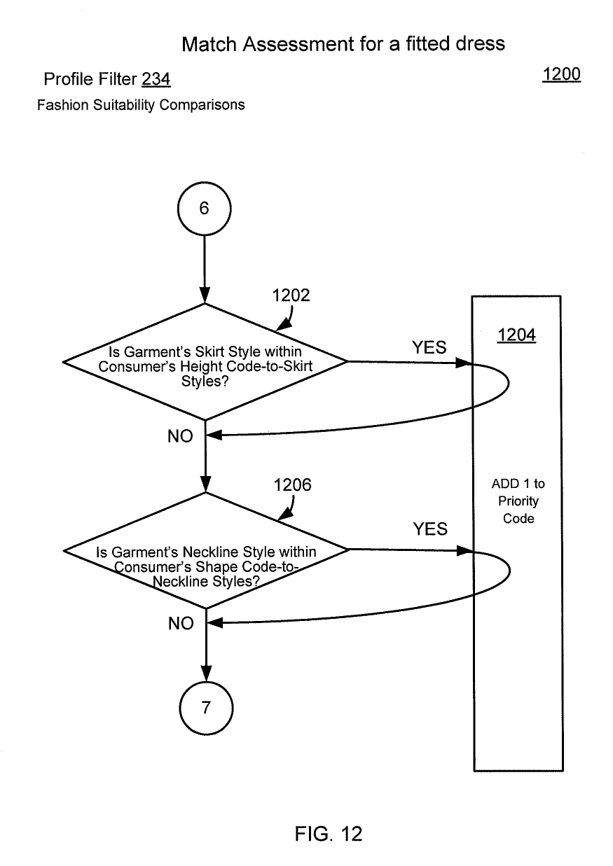

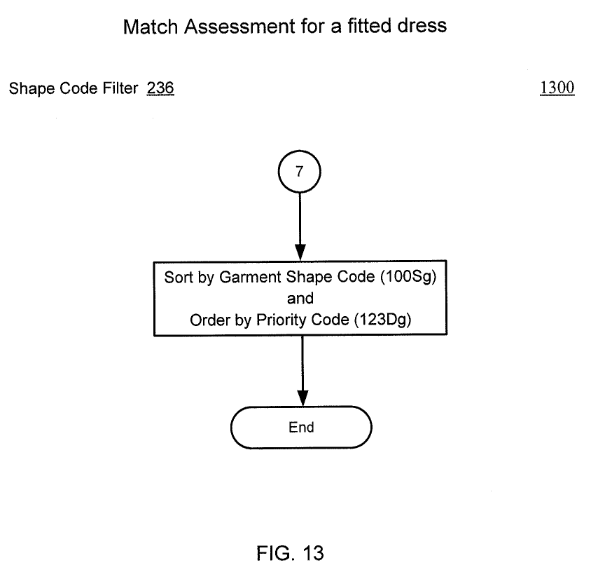

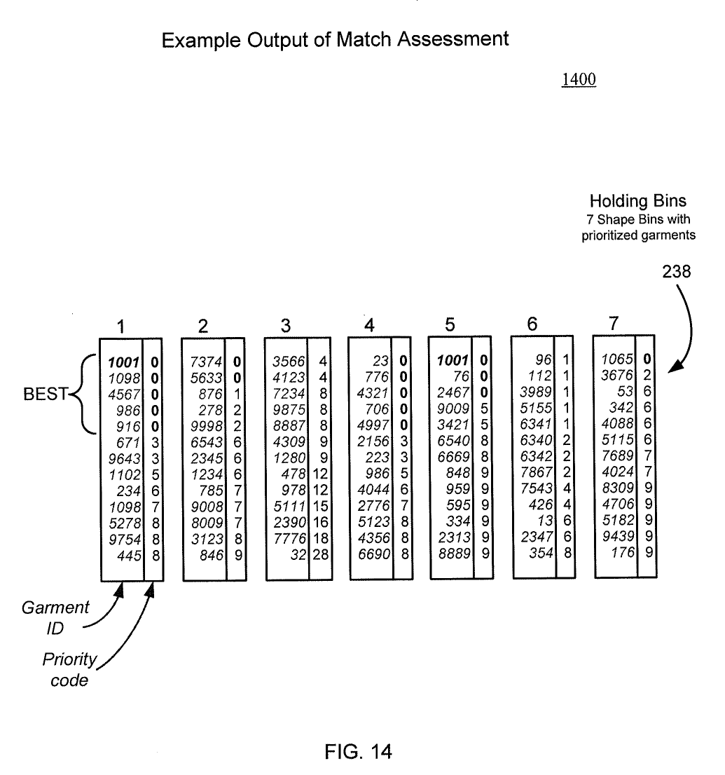

FIGS. 6-14 depict a match assessment process 230 and various elements thereof. The match assessment process treats both sewn clothing items and fashion accessories as garments. Thus it matches individual consumers with individual clothing items or individual accessories in the same manner and with equal efficacy. Further details of match assessment processes are taught in detail in Wannier I, II and/or III.

### Personalized Shopping Process

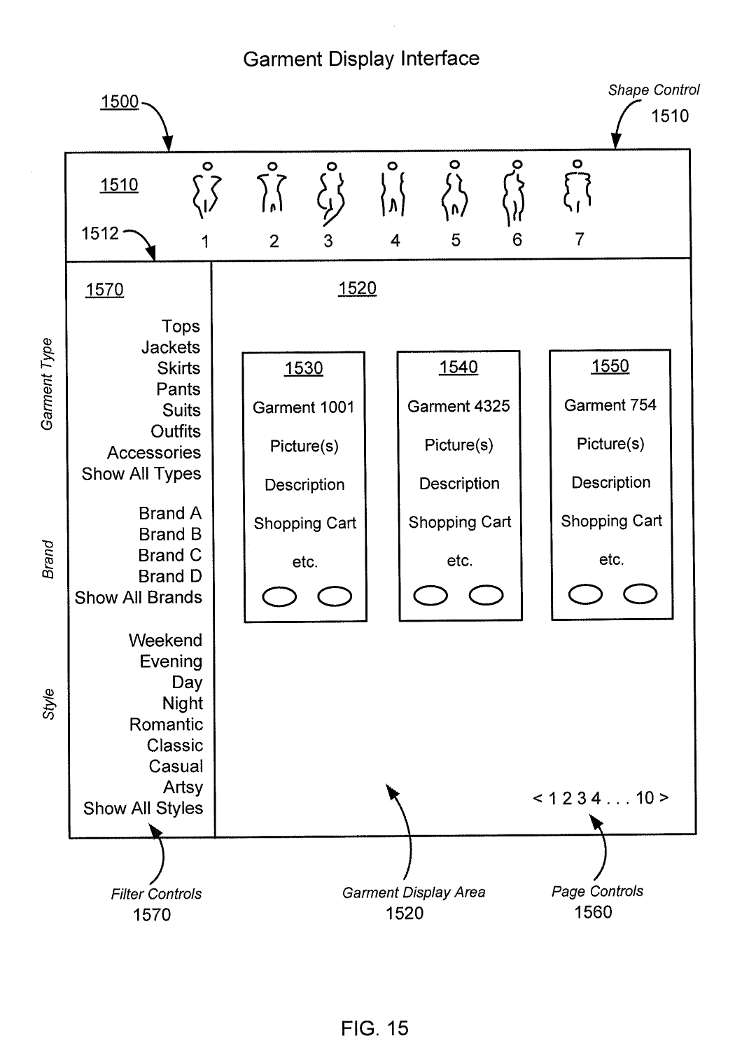

A personalized shopping process 240 presents a consumer with her personal online clothing store. In one embodiment, the consumer is presented with a personal store, which shows the customer garments, outfits and complementary accessories that match the customer's measurements, body shape, height code, personal preferences and fashion styling, that will fit her and flatter her as determined by the fashion suitability rules. In one embodiment, the results of a match assessment 230 of multiple garments and outfits may be displayed to the consumer using a graphical user interface (GUI) 1500 as depicted in FIG. 15. Further details of a personalized shopping process that might be used as the base for the present invention are taught in detail in Wannier I, II and/or III.

### Personal Mall

In addition to providing the consumer with a personalized store, elements of the systems described above can be expanded to cover a personal mall, wherein filtering is done as above, but over multiple online retail outlets. The particular retail outlets that are part of the system would depend on a number of criteria and the operator of the matching system might provide that access in exchange for commissions, as well as upselling, cross-marketing and providing other useful features for the consumer. An advantage to those retailers who join the personal mall and provide a virtual storefront is reduced return rates. With proper arrangement of the personal mall, each retail outlet can present its own brand and may be the shipper that ships the products directly to the consumer.

### Description of Embodiments

Among other teachings, a multi-partner shopping system is described that can be used for shopping for clothes and accessories, shoes, purses, and/or other products that include or embody notions of fashion and/or style. In one implementation, content is maintained on servers and served to browsers on request, with some content generated on the fly. The presentation of this material, collectively, by a server having access to the content is often referred to as a “website”, although the “location” of such a site is virtual and often in the minds of the users. Nonetheless, that shorthand is used herein and it should be understood that a website is content served by a physical computing system or a process running on a physical computing system. Likewise, when referring to operations that the “website” does or presents, it should be understood that those operations are performed by a processing device, processor, etc. executing instructions corresponding to the operations or perhaps specialized hardware, firmware or the like.

Online can refer to electronic communications and/or remote access of one computing system or device by another computing system or device, often those having client-server relationships. The access can be over a network of some sort or another. A common example used herein, but not intended to be limiting, is the Internet.

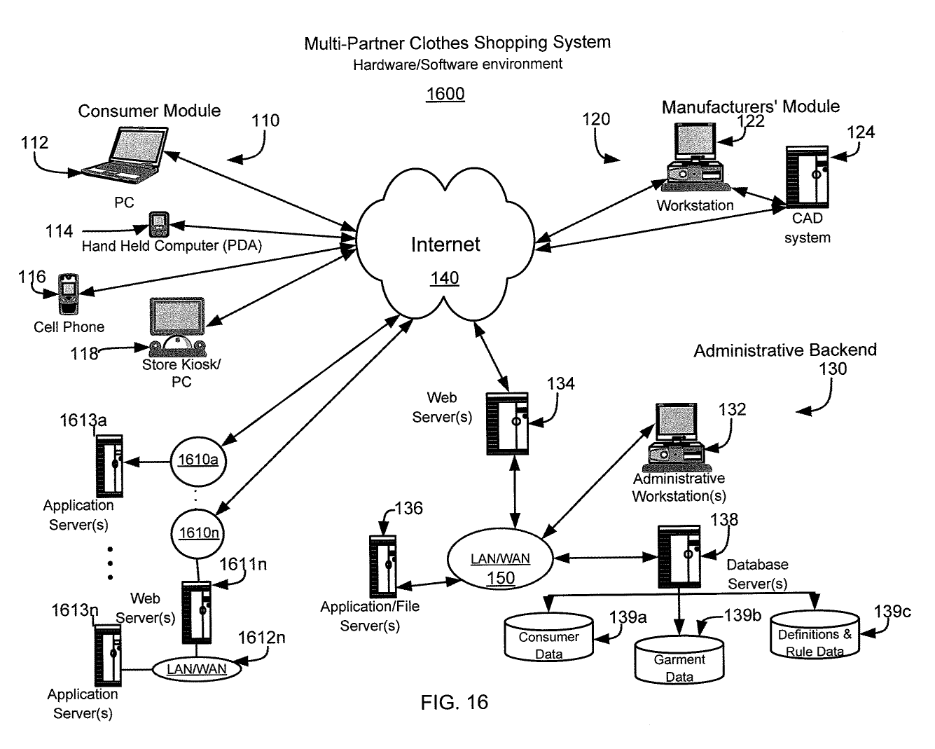

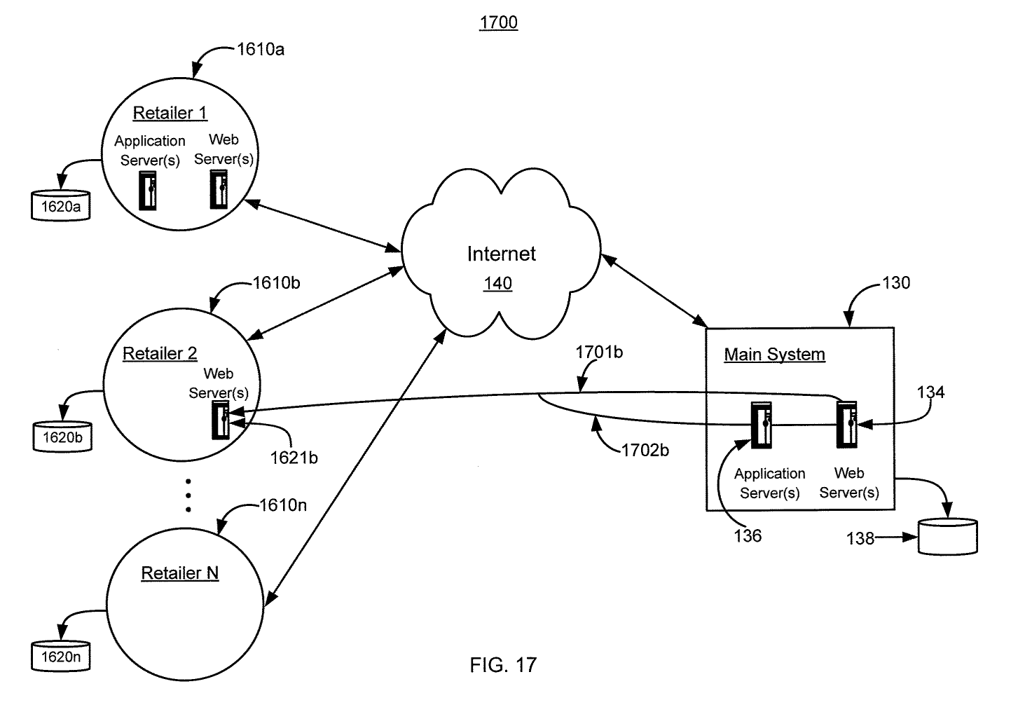

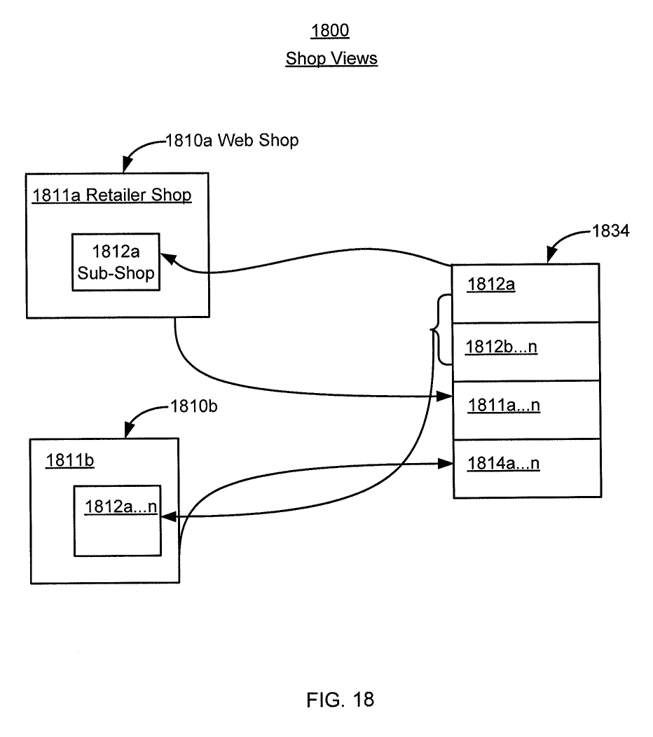

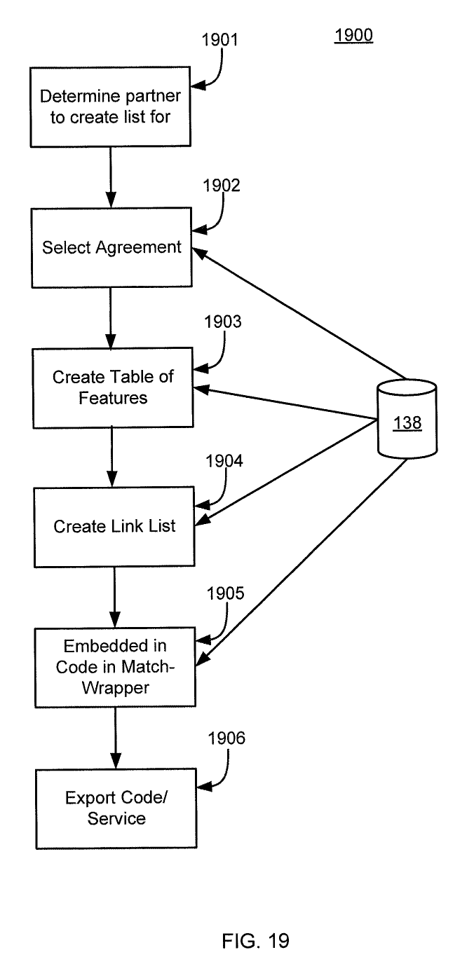

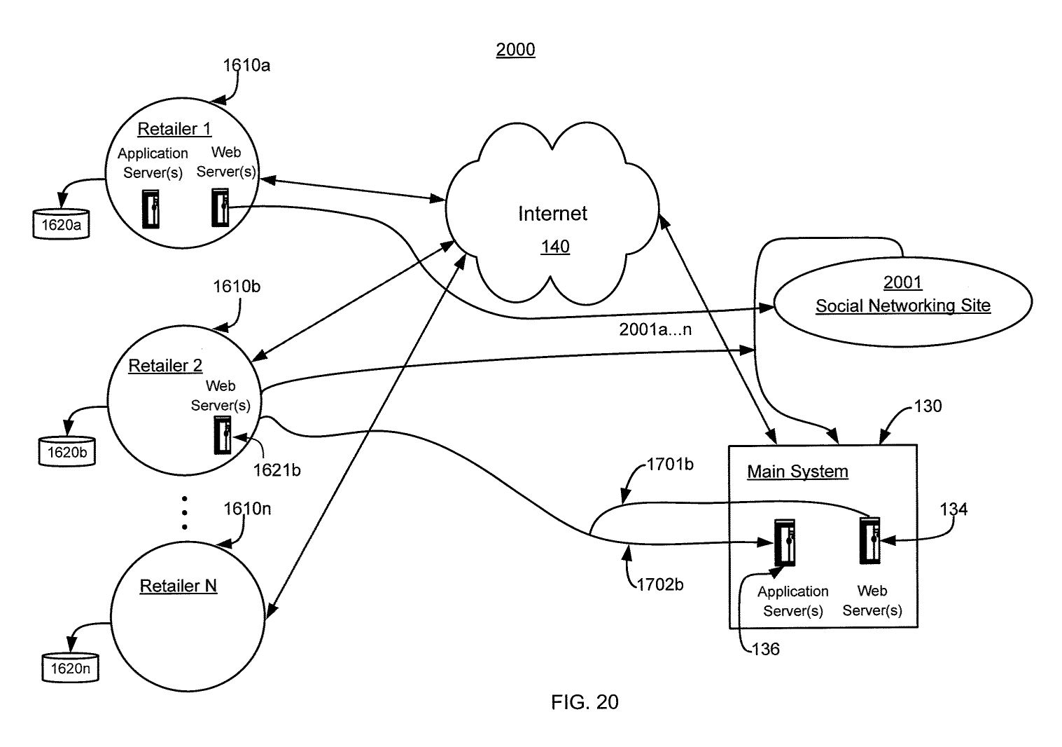

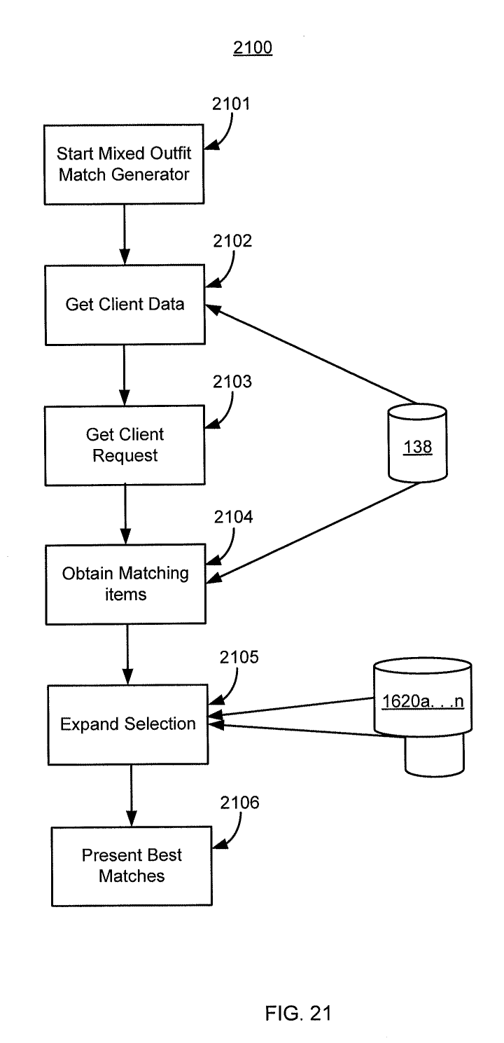

FIGS. 16-21 show an enhanced overview of a multi-partner clothes and accessories, shoes, purses, and all other products that include the notions of fashion and style, shopping system 1600. Further teachings along these lines are provided by Wannier III.

Using such a shopping system, several benefits are provided, such as a system and method for integrating embedded shops on multiple sites, linked to a virtual personal shopping channel where each person can instantly see within their personal shop the clothes and other fashion items that “match” a user's profile and fit and flatter within each node of the network. Those shops can be integrated with social networks and syndication of content for marketing products. The shopping system might generate product combinations from a plurality of inventories at a point of sale for a transaction and a system of soliciting interest in custom-made garments based on user indication, and in some cases including on-line closet representations of consumer-owned items.

The shopping system might allow for shopping of outfits or ensembles of items, allowing users to mix and match on any website or kiosk any part of such an outfit or ensemble, matching to other parts on other websites or items already owned by customer and/or known to the system.

### Categorization

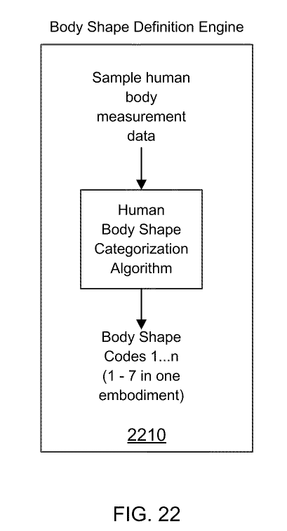

FIGS. 22-24 depict a categorization process 2205. In one embodiment, categorization process 2205 uses an engine 2210 that defines human body shapes as shape codes, an engine 2320 that categorizes individual consumers by shape and fit code, and an engine 2430 that categorizes individual garments by shape and fit codes.

FIG. 22 illustrates engine 2210 for defining human body shapes. In one embodiment, engine 2210 determines a list of critical measurements of the human body. Referring to FIG. 22, engine 2210 can process body measurements from representative samples of the human population and sub-populations (e.g., U.S. women aged 40-65). In one embodiment, engine 2210 processes the sample using the human body shape categorization process. Engine 2210 statistically analyzes the results to discern clustered subsets within the population, each sharing common data values.

### Categorize Individual Consumers

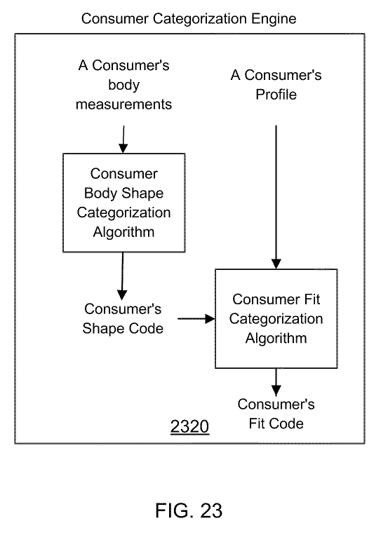

In one embodiment, engine 2320 receives an individual consumer's body measurements and inputs that data into a consumer body shape categorization algorithm. FIG. 23 illustrates one embodiment of engine 2320 to generate a consumer's fit code using a consumer body measurements and consumer profiles. In one embodiment, engine 2320 collects a consumer's profile, which can include data describing an individual consumer and his or her clothing preferences.

### Categorize Individual Garments

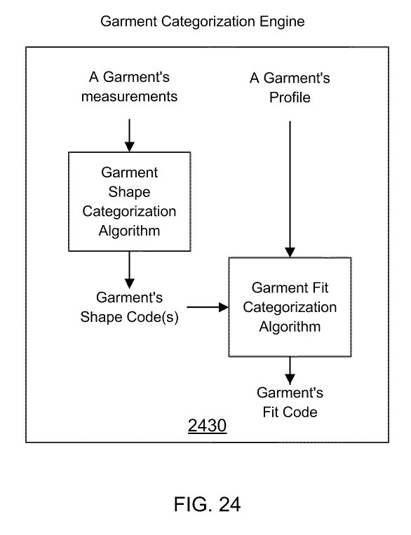

Referring to FIG. 24, engine 2430 employs a garment shape categorization process to process the garment measurement data. To derive a matching shape code, engine 2430 compares the garment's curves, derived from the measurements, to curves represented by each of the seven body shapes (other numbers of body shapes might be used) to determine whether the garment is suitable for one or more body shape. The curves are compared in front, side and back profiles. As stated above, the curves may also be compared three-dimensionally with the volume of the front half of a body shape being compared with the volume of the front half of the garment. Once matching curves are found, the garment is assigned its matching shape code(s). A ratings table of various style attributes is maintained in database 139c where positive or negative numbers represent the degree of suitability of each attribute for each body shape. For example, a puffed sleeve has a +2 rating for body shape #1 and a −1 rating for body shape #2, etc. A garment is a conglomeration of different style attributes (listed in garment record 229b) such as V-neckline, lantern sleeve shape, bubble skirt shape. For handling composite shape scores, the server accesses the style attribute table to obtain values corresponding to each of a garment's style attributes. The ratings values for each shape code are summed. If a sum does not exceed a certain threshold that shape code is eliminated. From these inputs, and possibly others, the server computes composite shape code scores for the garment and stores the computational results in the database records 139a.

### The Personalized Shopping Process

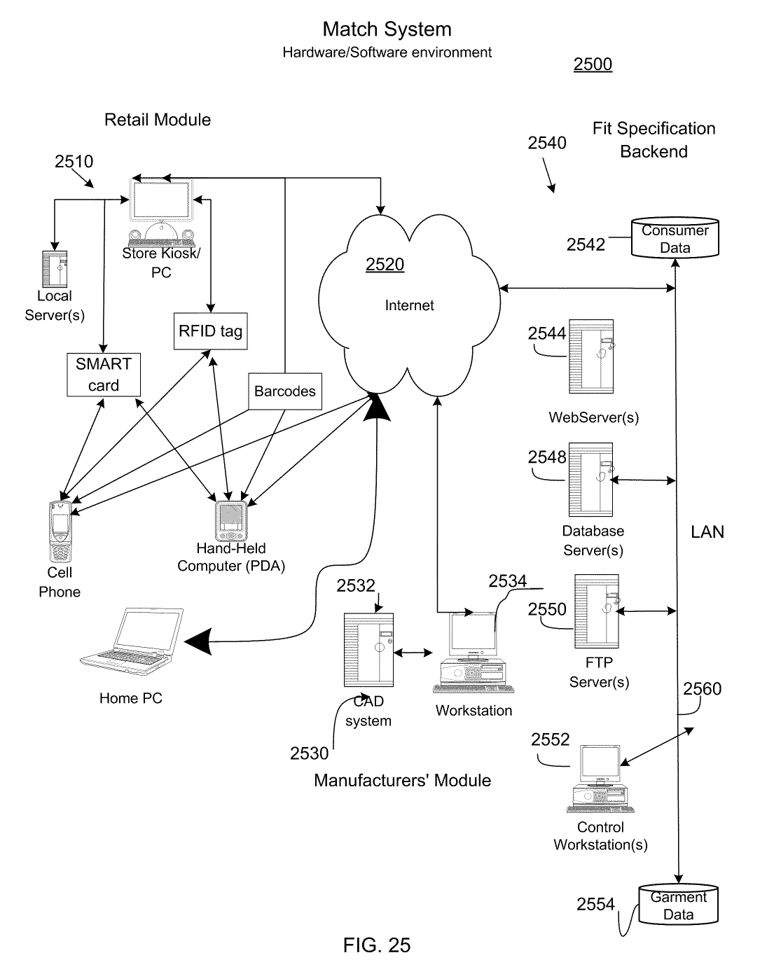

FIG. 25 depicts a match system 2500 used to enable a shopping process. Match system 2500 may make use of a network that may include web servers 2544, file and application servers, as well as database servers 2548, all operating in a networked environment that may include local area networks (LAN) 2560, wide area networks (WAN) and the Internet 2520. Data are transferred to match system 2500 and among its components. This may be achieved in a conventional fashion employing the standard suite of TCP/IP protocols, including Hypertext Transfer Protocol (HTTP) and File Transfer Protocol (FTP) for the transfer of various data. The eXtensible Markup Language (XML), an interchange format for the exchange of data across the Internet and between databases of different vendors and different operating systems, may be employed to facilitate data exchange and inter-process communication. Additional and fewer components, units, modules or other arrangement of software, hardware and data structures may be used to achieve the invention described herein.

Match system 2500 includes several interconnecting areas: the fit specification backend 2540, manufacturers' module 2530, and retail module 2510.

In one embodiment, fit specification backend 2540 contains web servers 2544, file server 2550, database 2548, and application servers 2552 that house the primary location for categorization and match assessment software. Match system 2500 also includes master databases of individual consumers' shape and fit codes 2542 and individual garments' shape and fit codes 2554.

The manufacturers' module 2530 is the software/hardware that allows a manufacturer to obtain shape and fit codes for their goods. For example, for each garment of a particular size or SKU, a manufacturer enters the garment's dimensional measurements and profile data into the manufacturers' module. This data may be entered manually or automatically by interfacing via a workstation 2534 for example, with the manufacturer's own internal systems, such as cad systems 2532. The data is subjected to garment categorization engine 2430, as described herein. This can occur locally or remotely through the fit specification backend 2540. The manufacturer may now employ the resultant shape and fit codes in the manufacturing process; for example, to print and/or electronically embed the shape code(s) and fit code on the garment's labels, sales tags, RFID tags, etc.

The retail module 2510 appears in two general areas: ‘bricks and mortar’ retail stores and online stores. Typically retail stores are located at malls, shopping centers, etc., while online stores are typically accessed via personal computers at home or office. The retail module 2510 may also be accessed through kiosks, cellular phones, PDAs and other freestanding or networked devices. It is through the retail module 2510 that a consumer can utilize the personalized shopping process. For example, Jane enters the women's Apparel section of a local department store. There she avails herself of the opportunity to receive her own personal shape and fit code. Her body measurements may be taken, e.g., automatically by means of a full body scanner. Her profile data is also collected and entered into the retail module 2510, which may be a software/hardware package residing at the store, or on a network. The resultant shape and fit codes may be returned to Jane in a variety of forms, such as a printed receipt, a magnetic card, or an integrated circuit card, etc.

In another embodiment, the shape and fits codes may be associated with another number or code, such as an item ID. For example, a manufacturer may use the item ID to look up garment information stored in a central database. The association may be used to link an arbitrary garment identifier, stored for example, in an RFID attached to the garment, with a shape and fit code stored in a database such as database 2548. Thus, the information about the garment can be either encoded into the identifier or stored in a database record pointed to by the identifier.

A consumer might prefer to shop away from the store, such as from home or at the office. He or she can access the retail module 140 via a computer or computing device and an online store. The consumer can avail himself or herself of the opportunity to receive his or her own personal shape and fit code.

For example, following on-screen instructions, someone can use a tape measure to collect body measurements and enter them into an online form, then enter profile information. This data is sent to fit specification backend 2540 for processing. A consumer's returned shape code is displayed or it is sent in an email containing the shape code and the fit code in a printable, machine-readable format, such as a barcode.

Like Jane, in the example above, the resultant shape and fit codes may be physically or electronically sent to a consumer in a variety of forms, such as a printed receipt, a magnetic card, or an integrated circuit card, etc. It may be forwarded to her cellular phone as a data file or an executable program. When shopping online, a consumer may access the retail module 2510 directly, or it may be presented to her through an online store, which subscribes to the retail module as a world-wide-web service. By tapping the match assessment process for many garments, retail module 2510 acts as clothing search engine.

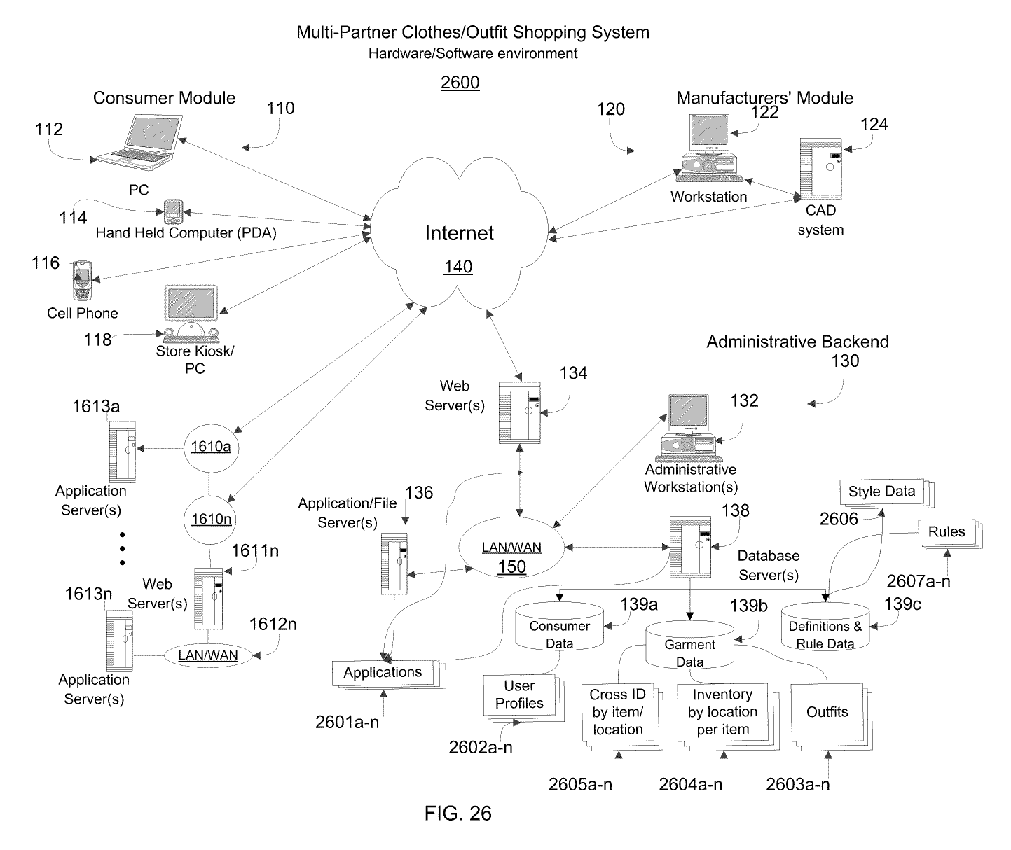

FIG. 26 shows an overview of an enhanced system 2600 according to one embodiment of the present invention. In addition to the system elements previously described above with respect to FIG. 16, system 2600 includes applications 2601a-n, which may run on application server(s) 136, web server(s) 134, and/or database server(s) 138. Also included are user profiles 2602a-n, data about outfits 2603a-n, inventory data indexed by the location of each item 2604a-n, and cross-IDs of item indexed by location 2605a-n, all of which data is stored on garment data repository 139b. Rules 2607a-n and style data 2606 are likewise stored in rules and definitions data repository 139c.

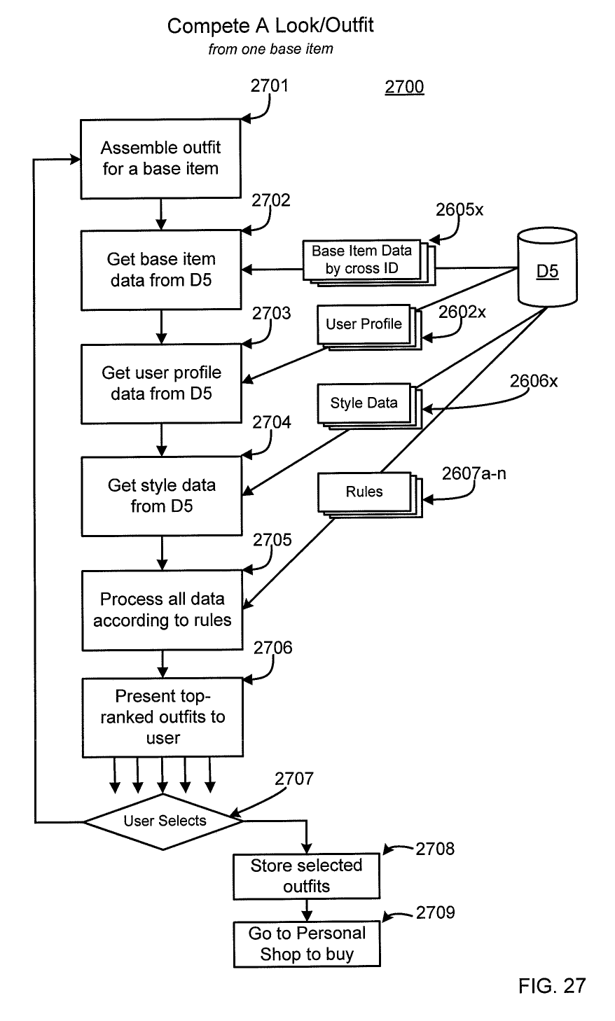

FIG. 27 shows a process 2700 to determine fashion products that complete a preferred look when given only information about the look desired by the user and at least one base item that would be part of that look. An example is matching a selected dress with one or more outer garments/accessories that match the preferred look, such as “classic.” In some cases, the system may propose a base item based on the users desired look profile. In step 2701, the user or the system identifies a base item and instructs the system to assemble an outfit to match said item. An outfit is a grouping of two or more garments and/or fashion accessories. In step 2702, the system retrieves data about the base item from data store 139b, using the item's cross ID 2605x. In step 2703, the system retrieves user profile 2602x, which includes data about fit and preferences, from data store 139a. In step 2704, the system retrieves style data 2606x from data store 139 (some pieces form at least one substore, depending on the situation and the details of implementation of data store 139 architecture and related databases, etc.)

In step 2705, the system processes data according to the rules 2607a-n stored in Definitions & Rules data store 139c and assembles one or more resulting outfits. Rules for assembling outfits are fashion rules as detailed in Wannier II. Fashion rules are defined in a collection of Fashion Suitability Tables, comprising of multivariate comparisons of data including, but not limited to, shape and height codes, garment type, fabric color and pattern, hair and skin color, neckline, sleeve and pocket styles, use, style, etc.

Rules defining the necessary constituent parts of an archetypal outfit and how its parts coordinate are expressed as an outfit template. Outfit Template Tables are stored in database 139c. Table 1 is an example of one outfit template.

TABLE 1
Outfit Template
Outfit ID O3301

| Parts | Attribute # | Attribute Name | Value |
|---|---|---|---|
| Part 1 | Jacket | | |
| | 102D | Garment Type | [jacket] |
| | 103D | Garment Type Code | [J1, J2] |
| | 106D | Brand | [Some Brand] |
| | 107D | Price | [100 < $$ <250] |
| | 115D | Color | [brown] |
| | 117D | Use | [career, special occasion, formal] |
| | 118D | Style | [classic, elegant] |
| | 119D | Fabric | [wool, polyester, rayon] |
| | 130D | Length Style | [high-hip, hip] |
| | 100Sg | Shape Codes | [1, 3, 4, 6, 7] |
| Part 2 | Skirt | | |
| | 102D | Garment Type | [skirt] |
| | 103D | Garment Type Code | [S1] |
| | 106D | Brand | [Some Other Brand] |
| | 107D | Price | [90 < $$ <230] |
| | 115D | Color | [brown] |
| | 117D | Use | [career, special occasion, formal] |
| | 118D | Style | [classic, elegant] |
| | 119D | Fabric | [wool, polyester, rayon] |
| | 114D | Skirt Style | [pencil] |
| | 130D | Length Style | [mid-calf] |
| | 100Sg | Shape Codes | [1, 2, 3, 4, 5, 6, 7] |
| Part 3 | Top | | |
| | 102D | Garment Type | [top] |
| | 103D | Garment Type Code | [T1, T2] |
| | 106D | Brand | [Yet Another Brand] |
| | 107D | Price | [$$ <125] |
| | 110D | Neckline | [V-neck, U-neck] |
| | 112D | Sleeve Style | [sleeveless, short] |
| | 115D | Color | [red] |
| | 117D | Use | [career, special occasion, formal] |
| | 118D | Style | [basic, casual, classic, elegant] |
| | 119D | Fabric | [cotton, polyester, rayon] |
| | 100Sg | Shape Codes | [1, 2, 3, 4, 5, 6, 7] |
| Part 4 | Handbag | | |
| | 102D | Garment Type | [accessory (handbag)] |
| | 103D | Garment Type Code | [A6] |
| | 106D | Brand | [any] |
| | 107D | Price | [$$>250] |
| | 115D | Color | [red] |
| | 117D | Use | [basic, career, casual, special |
| | | | occasion, formal] |
| | 118D | Style | [classic, elegant] |
| | 119D | Fabric | [leather] |
| | 100Sg | Shape Codes | [1, 2, 3, 4, 5, 6, 7] |

Coordination
Rules

| | | | |
|---|---|---|---|
| Parts = [1, 2] | | Dominant Color | HSV = [11-13, 25-99, 50-55] |
| Parts = [3, 4] | Consumer | Dominant Color | HSV = [355-359, 90-93, 90-95] |
| | Color Palette = | | |
| | [winter OR | | |
| | summer] | | |
| Parts = [3, 4] | Consumer | Dominant Color | HSV = [10-20, 90-93, 90-95] |
| | Color Palette = | | |
| | [autumn] | | |

This outfit template comprising of four parts: a jacket, top, skirt and handbag. Associated with each part are zero or more attributes (from the Garment Data Profile) each having a specified value. The specified value can be expressed alphanumerically as a single value, a range, and/or any logical comparison. In the above example, Part 1, the jacket, must be from brand ‘Some Brand’, have a price between $100-$250, and have a style of either classic or elegant.

An outfit template may also contain zero or more coordination rules, which specify how the parts interact and/or combine. Coordination rules are expressed as any kind of logical operation. In the above example, Parts 1 and 2, the jacket and skirt, must have a dominant color within a certain range. Here the range is specified using the commonly-known Hue, Saturation and Value color scheme (HSV). Their hue must be between 11 and 13, saturation between 25 and 99, and value between 50 and 55. This represents a ‘Chocolate Brown’ range of colors. Additionally, the coordination rules specify that if, in the consumer data record, the value for “color palette” is ‘winter’ or ‘summer’ then the processor might limit matches of garment records to those garment records for parts 3 and 4, the top and handbag, that fall in the ‘True Red’ range of colors. If, in the consumer data record, the value for “color palette” is “autumn”, then the processor might limit matches of garment records to those garment records that have a color field of “Orange Red”.

As detailed in Wannier I, the result of the Match Assessment Process is a prioritized list of garments/accessories that match a particular consumer (Wannier I, FIG. 5G). The computer applies an outfit template to the match assessment results as a search filter in order to find all possible combinations of garments meeting the rules and specifications of the outfit template. The result is a sorted, prioritized list of matching outfits, where each outfit is an array of the Garment IDs of its constituent parts together with a Priority Code.

Table 2 illustrates an example result set produced by running an Outfit Template Filter.

TABLE 2
Outfit Template Filter Results

| Outfit | | Priority |
|---|---|---|
| ID | Parts IDs | Code |
| 1 | 6543, 978, 6341, 5115 | 0 |
| 2 | 6543, 8461, 6341, 5115 | 0 |
| 3 | 6543, 8461, 6341, 345 | 4 |
| 4 | 3123, 978, 6341, 345 | 4 |
| 5 | 3123, 978, 2456, 5115 | 5 |
| 6 | 3123, 8461, 2456, 345 | 8 |
| 7 | 1788, 6432, 2456, 345 | 8 |
| 8 | 921, 6432, 2456, 8674 | 10 |

An outfit's Priority Code is assigned by calculating the median of the Priority Codes of its constituent parts. For example the Priority Codes for Garment IDs: 3123, 8461, 2456 & 345 of outfit ID #6 in Table 2 are 6, 8, 11 & 8, respectively. The median value of 6, 8, 11 & 8 is 8, making outfit ID #6's Priority Code equal to 8.

When applying an outfit template it is possible to supplement the template's Coordination Rules with one or more ad hoc rules. One useful application of ad hoc rules is to express a user's desired look. Consumer Jane indicates interest in outfits that have classic styling. She also likes blouses with V-shaped necklines. These constitute her desired look. Her desired look can be expressed as an ad hoc rule:

| | | | |
|---|---|---|---|
| Parts = [all] | 118D | Style | [=classic] |
| Parts = [IF 102D Garment Type = top] | 110D | Neckline | [=V-neck] |

Appending ad hoc rules to the outfit template further constrains the conditionals and can result in a more targeted result set. In this case, only outfits that have classic styling with tops having v-shaped necklines will be returned in the result set. Ad hoc rules can be added to multiple Outfit Template Filters. The result sets of multiple Outfit Template Filters can be combined into a single result set for presentation to the user.

In step 2706, the system presents the top-ranked outfits to the user. These outfits can be further categorized or grouped at the option of the user of the system by sub-categories and characteristics (e.g., special occasion for particular geography, price range, type of occasion—wedding vs. casual party, etc.), and in step 2707, the user indicates one or more choices. If the user selects one or more outfits (OK), the process moves to step 2708, where the system links to the online store(s) where the user may purchase elements of the outfit, and in step 2709, the user visits the shop(s) online to buy outfit elements or in some cases buys all the items in one step through the “uber-checkout”.

The uber-checkout, whose functions are discussed earlier, enables the customer to see one shopping cart and “behind the scenes” the items are ordered, or the shopping carts of partner sites are completed (in robot fashion) by the system, for the user so that the user doesn't have to go visit each site. The “uber-checkout” manages the process of communicating with each of the separate sites and informing the customer and interfaces with other servers who represent shipping/manufacturing or other supply resources. If, in step 2707, the user does not select any of the proffered outfits, or for any other reason wants to make another search, the process loops back to step 2701 to determine fashion products that complete a preferred look.

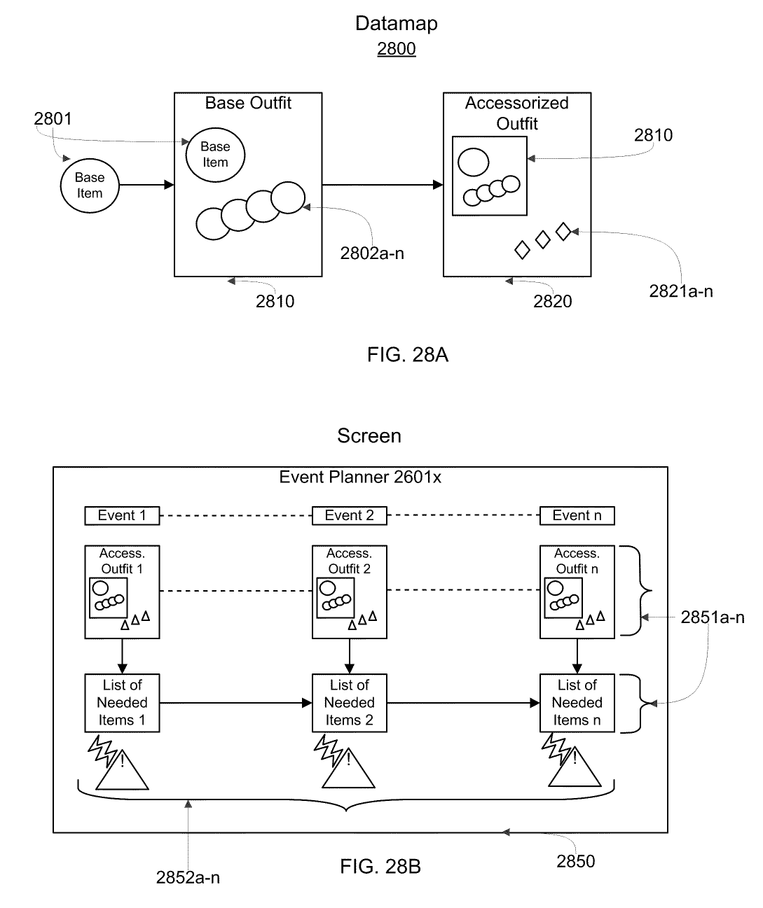

FIG. 28A shows an exemplary datamap 2800 indicating how data is organized structurally to allow the system to determine fashion products for a specific event when given only information about the event and at least one base item that the user wishes or the systems suggests wearing to an event. A base item might be a skirt, pants or a dress, for example (or any other piece). Based on this base item 2801, a base outfit 2810 is assembled, containing additional pieces 2802 a-n, which are added based on a style desired as indicated by a user and using rules, for example to maximize use of closet items the user already owns. For example, the user may instruct the system to create an outfit around the base item skirt and also using a blouse that matches the skirt. Or in other cases the user may tell the system to go for a new fashion look, or in yet other cases, for the most cost-effective solution. Then that base outfit 2810 is further accessorized into an accessorized outfit 2820, by adding, for example, a scarf, etc., as represented by accessories 2821a-n, again applying the user's rules.

FIG. 28B shows an exemplary computer screen 2850 with event planner application 2601x open on the screen. Events 1-n run across from left to right, for example, and under each an accessorized outfit 2851a-n is shown. These outfits are instantiations of the example outfit 2820 discussed above. The system applies all the same rules, plus additional rules to avoid the user wearing the same outfit to events frequented by same group of people. Then the inventory of products 2604a-n is compared to the user profile 2602x to remove items that do not fit or flatter the user, and a set of lists 2851a-n of items needed to complete each outfit is formed. The system sends alerts 2852a-n, reminding the user, as each event approaches, to obtain all the needed items on the event list. Then in some cases, the system screens the remaining items for appropriate products and tentative orders can be scheduled. In another case, the customer may indicate items in their closet that they would like to resell to other similar customers—so the outfit builder may also extend to items in other customers' closets that they have marked as part of the inventory virtually available for inclusion/resale.

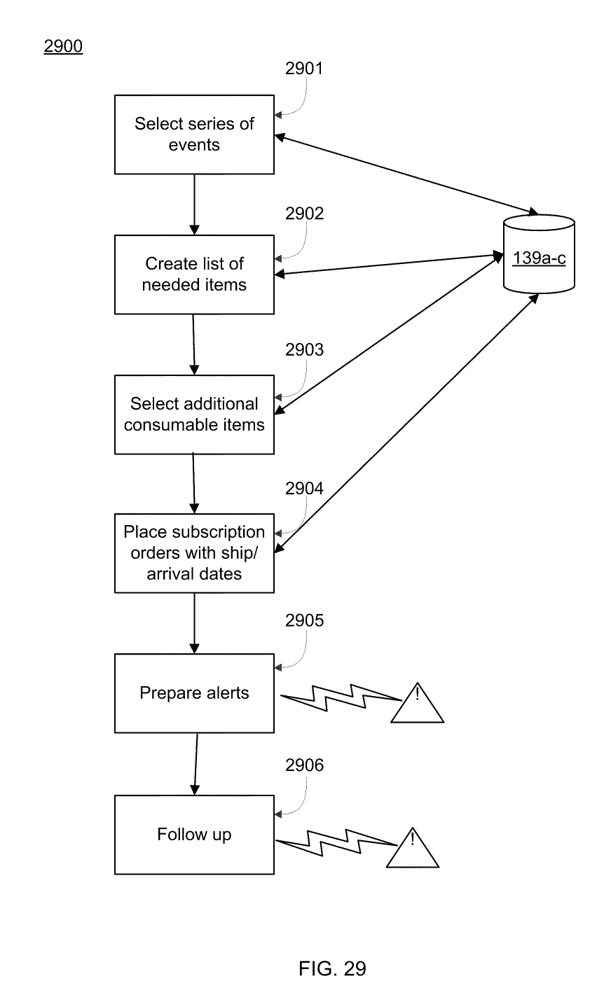

FIG. 29 shows a process 2900 that recommends products, optionally outfits, for specific events, to users who subscribe to a service. In step 2901, the system selects a series of events from data store 139a-c, or in some cases from a user's calendar, phone, etc. In step 2902, the system creates lists of needed items (components) for outfits for each event. In step 2903, consumables may be added. So the system can calculate the required quantity of such consumables, a special kind of item that expires after a number of uses, and hence needs to be replaced, even if it exists in the user's closet. For example, a user may specify that she wears her stockings only twice. In step 2904, the system places subscription orders with desired shipping and or arrival dates, sufficiently ahead of events. In step 2905, alerts may be programmed, to allow user to know what items to expect when.

In some cases, in additional step 2906, the system does a follow up to see if user was satisfied with quality and timeliness of delivery. As the system provides a pre-chosen plurality of products to users in exchange for a regular payment made at specific time intervals, thus subscribing users may receive a coordinated set of products, such as a clothing outfit, on a regular basis, after entering an agreement on frequency and type of product combinations to be delivered. A database and software instance for generating product combinations provides them by sending the product combinations to the users paying a regular fee according to the agreement, optionally in accordance with any user specifications of parameters that guide the product combination selected by the database and software instance. Also, the user may be given an RFID scanner, allowing the user to assemble the correct outfits from the closet easily, at the time of the event(s).

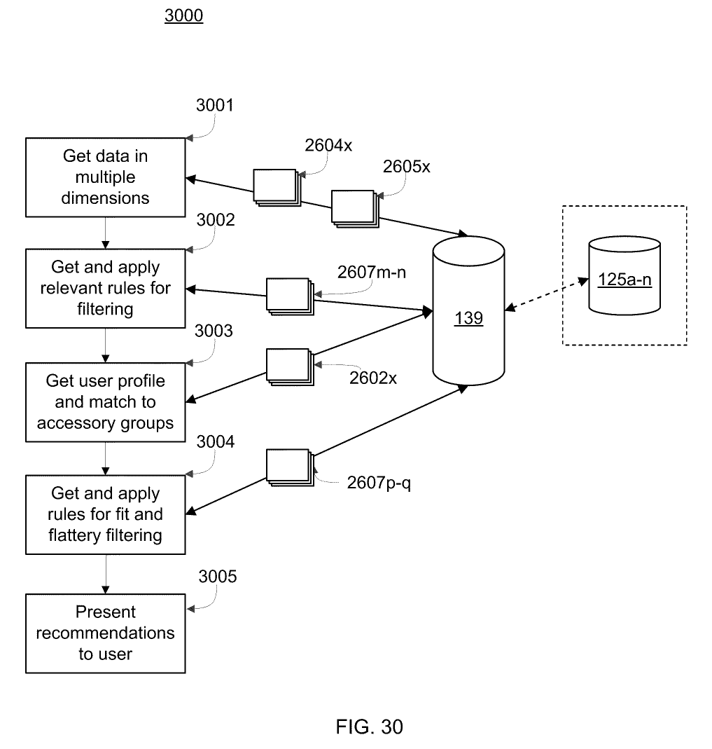

FIG. 30 shows an exemplary process 3000 for a system of assigning fashion accessories, such as jewelry and shoes, to categories that can be used to better match users with accessories that fit and flatter them. In step 3001 the system obtains data from one or more parties involved in the design, distribution, or manufacture of the accessory, by primarily accessing data store 139, but in some cases, either automatically or on request, additional inquiries are made to datastores 125a-n of one or more suppliers and partners at their premises 3020a . . . n Then in step 3002 rules 2607m-n are used by application 2601x to categorize accessories into one or more groups, such as, for example, elegant or casual. In step 3003, the system refers to user profile 2602x to get user data (body type, measurements, coloring, etc.) and match said user data to one or more accessory groups. In step 3004, rules 2607p-q are used by application 2601y to determine the expected level of fit and flattery of the specific accessory on the specific body. In step 3005, the system presents the resulting accessory recommendations to the user. Note that, optionally, accessories can be assigned to all groups (if they are suitable for all body types).

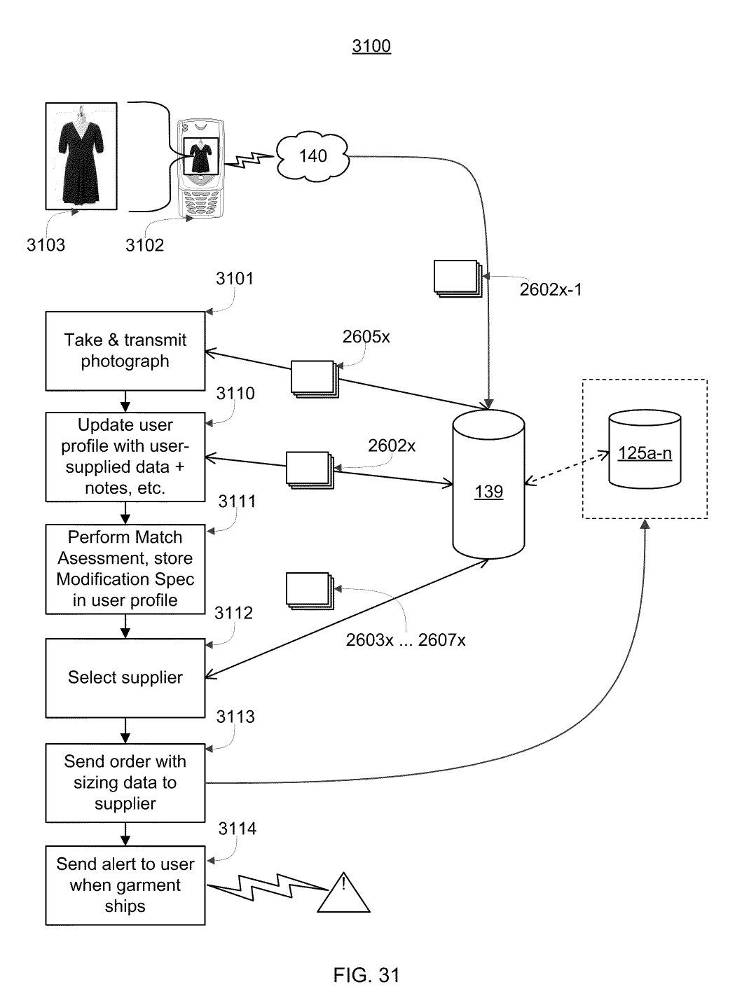

FIG. 31 shows an exemplary process 3100 for a method of providing garments in a variety of sizes based on alteration of a garment portrayed in an image, thus increasing the range of options users have for obtaining clothing, without increasing the quantity of available samples to encompass every possible size of a garment. Previous to step 3101, the system takes or obtains a photograph 3102 of garment 3103 and transmits the garment image and size data by means, for example, of a cellular phone system 3105 through the Internet 140 or some other, similar public or private network to the user profile 2602x-1 in data store 139. When the picture arrives in the user's profile (as part of 2602x-1), it is made available to the user, for example on the kiosk 118, by email, in the user's personal shop, or by some other way.

In addition to the photo, the available information, such as the subject or message text of an email, could contain additional data about the garment, supplemented with data from data store 139 and, in some cases, from datastores 125a-n of one or more suppliers and partners. In step 3110, the system updates user profiles 2602x in data store 139 to store information provided by the user (including the picture of the garment that is already in the profile and or additional pictures, for example from an non-participating website). At step 3111 the system performs a match assessment (as taught in Wannier I, II & III) comparing the garment to the user. During this match assessment the system records a modification specification which details the extent to which the garment passes or fails each of the fit comparisons. For example, the match assessment process determines a pant passes the Hip Circumference Comparison, meaning the user's hip circumference falls within the acceptable tolerance range at the pant's hip. The system records in the modification specification that the pant's hip needs no adjustment. However, the assessment determines that the pant fails the Waist Circumference Comparison as the pant's waistband is 3 inches larger than the user's waist circumference and it falls outside the acceptable tolerance range given the user's fit preference. The system records in the modification specification that the pant's waistband needs an adjustment of −3 inches. The system uses Garment Categorization Engine 2430 to determine if any of the garment's shape codes match the user's shape code. If there is not a match the system follows expert fashion rules 139c to determine and specify alterations to one or more of the garment's style details in order to achieve a matching shape code. For example, “widen the lapels by 2 inches and change the neckline style from bateau to V-neck”. In this way the modification specification contains the sizing and styling alteration data needed by the manufacturer to modify the garment so it will correctly fit and flatter the buyer. The complete modification specification is stored in user profiles 2602x at step 3111. In step 3112 the system (sometimes with input from user) identifies and or selects one or more suppliers and partners to produce the garment modified to fit the user. In step 3113, the system sends the order for the garment, along with the buyer's sizing data, to the garment supplier. In step 3114, the system sends an alert to the user when the garment is ready to be shipped.

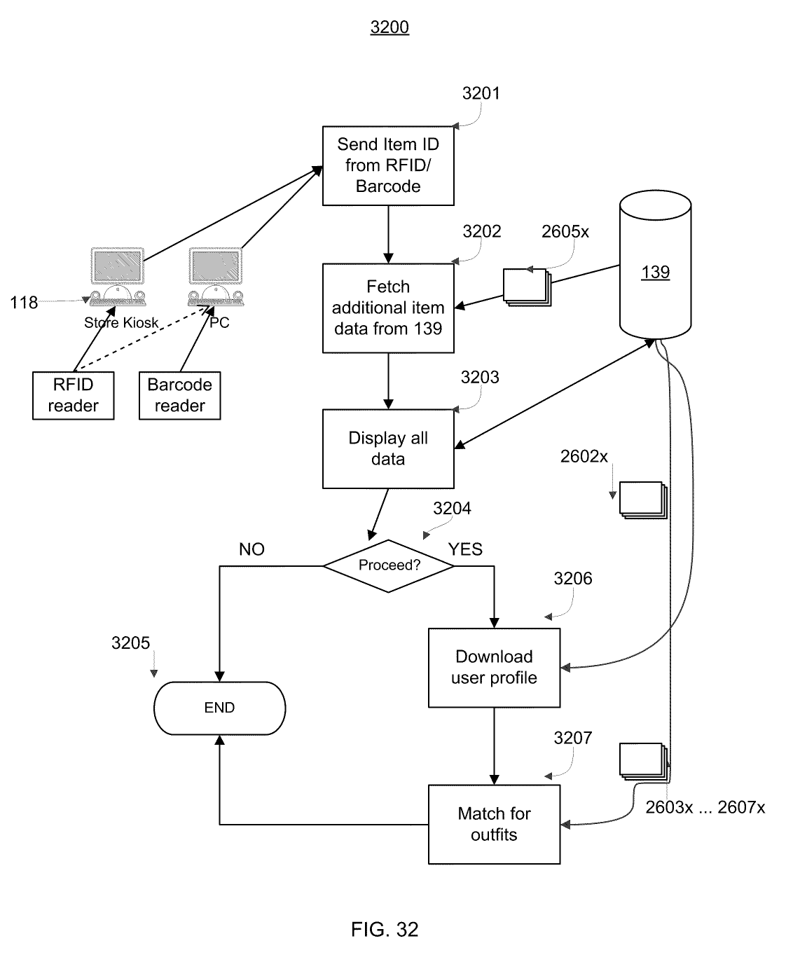

FIG. 32 shows a system 3200 according to one embodiment of the current invention for using Radio Frequency Identification (RFID) tags and electronic garment profiles, such as a shape code. Such detailed garment profiles on attached RFID tags can help users identify and assess garments. In system 3200, electronic garment profiles are encoded onto RFID tags and barcodes garments in kiosk 118 by a PC. In step 3201 the system sends the ID on the RFID or UPC barcode of an item provided by the user. In step 3202, the system obtains additional information about the item from the garment ID 2605x in data store 139. In step 3203 the data is displayed. In step 3204 the process branches. If no further information is required by the system to complete an outfit, the process is done (yes), and it terminates at step 3205. If more information is needed, the process moves to step 3206, where the system downloads user profile 2602x. Then in step 3207, the system compares the user profile to inventory data to see how many outfits can be assembled that suit the user, and the process ends at step 3205.

It should be clear that many modifications and variations of this embodiment may be made by one skilled in the art without departing from the spirit of the novel art of this disclosure. For example, in some cases customers may “shop together” in a “chat shop” approach, using means for online real time communication that are well know in current art, such as linking, for example, to Internet telephone and instant messaging systems, etc. Thus customers are shopping together while chatting, so each chatter can see the shop together with the others, and both synchronously and asynchronously add comments, etc. can buy a gift for the chattee's shop, etc. These modifications and variations do not depart from the broader spirit and scope of the invention, and the examples cited here are to be regarded in an illustrative rather than a restrictive sense.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

1. An online garment selection and acquisition system comprising at least a server computer system that receives requests from client computer systems and/or client devices and responds to those requests, wherein the server computer system is configured to be able to access a database system for reading data therefrom, online garment selection and acquisition system comprising:
a database system that includes a database server and a database for an inventory of garments, wherein the inventory of garments includes garments provided from a plurality of partner manufacturers and the database includes a plurality of type parameters for garments in the inventory and at least at least one fit, shape, preference or style parameter;
program code for obtaining consumer data including one or more of consumer body shape, consumer proportion, consumer preferences;
program code for filtering the collection of garments according to one or more of consumer preference, consumer size, consumer measurements, consumer shape and parameters of the garments in the database to form a personalized selection of garments;
program code for matching a plurality of garments to form an outfit record, wherein an outfit record comprises data including a list of garment identifiers identifying the plurality of garments that match to form at least a portion of an outfit comprising garments deemed consistent and thereby forming an outfit; and
program code for generating a presentation of at least a portion of the outfit to allow for a consumer or consumer representative using the client computer systems and/or client devices to select and/or acquire the matched outfit.

2. The online garment selection and acquisition system of claim 1, wherein the database of garments comprises clothing, shoes, accessories and/or other fashion items that can be grouped into outfits.

3. The online garment selection and acquisition system of claim 1, further comprising program code for accepting product feeds from a plurality of partner manufacturers.

4. The online garment selection and acquisition system of claim 1, wherein the client computer systems comprise one or more of in-store kiosks, home computers, general purpose computers, handheld devices, laptop computers, cellular telephones, PDAs, and/or netbook computers.

5. The online garment selection and acquisition system of claim 1, wherein the program code for filtering is program code for filtering based on calculations that estimate a degree to which a garment or accessory might fit or flatter the consumer, given one or more of the characterization of the garment or accessory, a list of fashion rules defined in a computer-readable data structure, and the consumer body shape, measurements and/or fit preferences.

6. The online garment selection and acquisition system of claim 1, further comprising a display device as part of the client computer systems, wherein the display device is configured to display the generated presentation and the client system is configured to accept navigation commands from the consumer or consumer representative and to accept input commands from the consumer or consumer representative that signal selection requests.

7. The online garment selection and acquisition system of claim 1, wherein the garments include at least one fashion accessory, wherein the further comprising a display device as part of the client computer systems, wherein the consumer data comprises one or more of consumer hair color, face shape, shoulder shape, eye color, and skin color, and wherein the fashion accessory is represented in the database with style parameters in a garment profile, thereby facilitating automated outfit generation.

8. The online garment selection and acquisition system of claim 1, wherein the garments include at least one unmanufactured item that is to be manufactured after selection by the consumer or consumer representative, the system comprising:
program code to generate a manufacturing request message to a manufacturer, wherein the manufacturing request message includes at least an indication of a pattern to use and adjustments to the pattern that are based on at least a part of the consumer data.

9. An online garment selection and acquisition system comprising at least a server computer system that receives requests from client computer systems and/or client devices and responds to those requests, wherein the server computer system is configured to be able to access a database system for reading data therefrom, online garment selection and acquisition system comprising:
a database system that includes a database server and a database for an inventory of garments, wherein the inventory of garments includes garments provided from a plurality of partner manufacturers and the database includes a plurality of type parameters for garments in the inventory and at least at least one fit, shape, preference or style parameter;
program code for obtaining consumer data including one or more of consumer body shape, consumer proportion, consumer preferences;
program code for filtering the collection of garments according to one or more of consumer preference, consumer size, consumer measurements, consumer shape and parameters of the garments in the database to form a personalized selection of garments;
program code for generating a presentation of a garment matching the filtering wherein the presentation is for a garment not yet manufactured that is to be manufactured after selection by the consumer or consumer representative; and
program code to generate a manufacturing request message to a manufacturer, wherein the manufacturing request message includes at least an indication of a pattern to use and adjustments that are based on at least a part of the consumer data.

10. The online garment selection and acquisition system of claim 9, wherein adjustments comprise adjustments to one or more feature that would alter a characterization of the garment from a garment that would not satisfy the filtering to a garment that would satisfy the filtering.

11. The online garment selection and acquisition system of claim 9, wherein adjustments comprise adjustments to one or more of a style detail, an ease, a cloth pattern, and an angle of cut.

12. The online garment selection and acquisition system of claim 11, wherein style details include collar shape, sleeve length, and garment embellishments.
